(19) United States
(12) Patent Application Publication
(10) Pub. No.: US 2025/0379695 A1
(43) Pub. Date: Dec. 11, 2025

(54) DATA BEARING VIRTUAL PILOTS

(71) Applicant: QUALCOMM Incorporated, San Diego, CA (US)

(72) Inventors: Chih-Hao LIU, San Diego, CA (US); Jing SUN, San Diego, CA (US); Somsubhra BARIK, San Diego, CA (US); Eric Paul SOLLENBERGER, Broomfield, CO (US); Jing JIANG, San Diego, CA (US)

(21) Appl. No.: 18/737,795

(22) Filed: Jun. 7, 2024

(51) Int. Cl. H04L 5/00; H04L 1/00

(52) U.S. Cl. CPC H04L 5/005; H04L 1/0003

(57) ABSTRACT

Some wireless communication systems utilize reference signals to characterize a channel to aid in data symbol demodulation and decoding. In some approaches, the virtual pilots may be reconstructed from data resource elements (REs) of a channel. In some examples, a first wireless device may receive, in a slot and via a channel from a second wireless device, a first data symbol that is a first virtual pilot symbol with a first modulation scheme. The first wireless device may receive, in the slot and via the channel from the second wireless device, a second data symbol with a second modulation scheme, where the first modulation scheme is different from the second modulation scheme. The first wireless device may decode the second data symbol in association with a first estimate of the channel from the first virtual pilot symbol with the first modulation scheme.

### FIELD OF TECHNOLOGY

The following relates to wireless communications, including data bearing virtual pilots.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a first wireless device is described. The method may include receiving, in a slot and via a channel from a second wireless device, a first data symbol that is a first virtual pilot symbol with a first modulation scheme, receiving, in the slot and via the channel from the second wireless device, a second data symbol with a second modulation scheme, where the first modulation scheme is different from the second modulation scheme, and decoding the second data symbol in association with a first estimate of the channel from the first virtual pilot symbol with the first modulation scheme.

A first wireless device is described. The first wireless device may include one or more memories storing processor executable code, and one or more processors coupled with the one or more memories. The one or more processors may individually or collectively be operable to execute the code to cause the first wireless device to receive, in a slot and via a channel from a second wireless device, a first data symbol that is a first virtual pilot symbol with a first modulation scheme, receive, in the slot and via the channel from the second wireless device, a second data symbol with a second modulation scheme, where the first modulation scheme is different from the second modulation scheme, and decode the second data symbol in association with a first estimate of the channel from the first virtual pilot symbol with the first modulation scheme.

Another first wireless device is described. The first wireless device may include means for receiving, in a slot and via a channel from a second wireless device, a first data symbol that is a first virtual pilot symbol with a first modulation scheme, means for receiving, in the slot and via the channel from the second wireless device, a second data symbol with a second modulation scheme, where the first modulation scheme is different from the second modulation scheme, and means for decoding the second data symbol in association with a first estimate of the channel from the first virtual pilot symbol with the first modulation scheme.

A non-transitory computer-readable medium storing code is described. The code may include instructions executable by one or more processors to receive, in a slot and via a channel from a second wireless device, a first data symbol that is a first virtual pilot symbol with a first modulation scheme, receive, in the slot and via the channel from the second wireless device, a second data symbol with a second modulation scheme, where the first modulation scheme is different from the second modulation scheme, and decode the second data symbol in association with a first estimate of the channel from the first virtual pilot symbol with the first modulation scheme.

Some examples of the method, first wireless devices, and non-transitory computer-readable medium described herein may further include operations, features, means, or instructions for receiving, via the channel from the second wireless device, a first overhead symbol of a reference signal in the slot with the first data symbol and the second data symbol, where a reconstruction of the first virtual pilot symbol may be performed in association with a second estimate of the channel from the reference signal.

In some examples of the method, first wireless devices, and non-transitory computer-readable medium described herein, the first estimate of the channel may be determined in association with the reconstruction of the first virtual pilot symbol.

Some examples of the method, first wireless devices, and non-transitory computer-readable medium described herein may further include operations, features, means, or instructions for receiving, via the channel from the second wireless device, a third data symbol that may be a second virtual pilot symbol with a third modulation scheme, where the third modulation scheme may be equal to, or different from, the first modulation scheme.

In some examples of the method, first wireless devices, and non-transitory computer-readable medium described herein, the third data symbol may be received after the first data symbol in the slot.

In some examples of the method, first wireless devices, and non-transitory computer-readable medium described herein, a transport block size may be associated with the first modulation scheme and the second modulation scheme.

In some examples of the method, first wireless devices, and non-transitory computer-readable medium described herein, the first modulation scheme may be a first modulation and coding scheme (MCS), the second modulation scheme may be a second MCS different from the first MCS, the first data symbol may be encoded with the first MCS, and the second data symbol may be encoded with the second MCS.

Some examples of the method, first wireless devices, and non-transitory computer-readable medium described herein may further include operations, features, means, or instructions for receiving, via the channel from the second wireless device, a third data symbol that may be a second virtual pilot symbol with a third MCS, where the third MCS may be equal to, or different from, the first MCS.

In some examples of the method, first wireless devices, and non-transitory computer-readable medium described herein, the first data symbol may be encoded in a first code block with a first code rate, and the second data symbol may be encoded separately from the first code block in a second code block with a second code rate.

Some examples of the method, first wireless devices, and non-transitory computer-readable medium described herein may further include operations, features, means, or instructions for communicating, with the second wireless device, an indication of a configuration of the first modulation scheme for the first data symbol that may be the first virtual pilot symbol.

In some examples of the method, first wireless devices, and non-transitory computer-readable medium described herein, the indication may be received in a first control information field associated with the first virtual pilot symbol that may be separate from a second control information field associated with the second data symbol.

In some examples of the method, first wireless devices, and non-transitory computer-readable medium described herein, the indication may be an offset relative to a second MCS associated with the second data symbol.

In some examples of the method, first wireless devices, and non-transitory computer-readable medium described herein, the configuration includes one or more locations in time or frequency of the first data symbol that may be the first virtual pilot symbol.

A method by a second wireless device is described. The method may include transmitting, in a slot and via a channel to a first wireless device, a first overhead symbol of a reference signal for a reconstruction of a first virtual pilot symbol, transmitting, in the slot and via the channel to the first wireless device, a first data symbol that is the first virtual pilot symbol with a first modulation scheme, and transmitting, in the slot to the first wireless device, a second data symbol with a second modulation scheme, where the first modulation scheme is different from the second modulation scheme.

A second wireless device is described. The second wireless device may include one or more memories storing processor executable code, and one or more processors coupled with the one or more memories. The one or more processors may individually or collectively be operable to execute the code to cause the second wireless device to transmit, in a slot and via a channel to a first wireless device, a first overhead symbol of a reference signal for a reconstruction of a first virtual pilot symbol, transmit, in the slot and via the channel to the first wireless device, a first data symbol that is the first virtual pilot symbol with a first modulation scheme, and transmit, in the slot to the first wireless device, a second data symbol with a second modulation scheme, where the first modulation scheme is different from the second modulation scheme.

Another second wireless device is described. The second wireless device may include means for transmitting, in a slot and via a channel to a first wireless device, a first overhead symbol of a reference signal for a reconstruction of a first virtual pilot symbol, means for transmitting, in the slot and via the channel to the first wireless device, a first data symbol that is the first virtual pilot symbol with a first modulation scheme, and means for transmitting, in the slot to the first wireless device, a second data symbol with a second modulation scheme, where the first modulation scheme is different from the second modulation scheme.

A non-transitory computer-readable medium storing code is described. The code may include instructions executable by one or more processors to transmit, in a slot and via a channel to a first wireless device, a first overhead symbol of a reference signal for a reconstruction of a first virtual pilot symbol, transmit, in the slot and via the channel to the first wireless device, a first data symbol that is the first virtual pilot symbol with a first modulation scheme, and transmit, in the slot to the first wireless device, a second data symbol with a second modulation scheme, where the first modulation scheme is different from the second modulation scheme.

Some examples of the method, second wireless devices, and non-transitory computer-readable medium described herein may further include operations, features, means, or instructions for transmitting, via the channel to the first wireless device, a third data symbol that may be a second virtual pilot symbol with a third modulation scheme, where the third modulation scheme may be equal to, or different from, the first modulation scheme.

In some examples of the method, second wireless devices, and non-transitory computer-readable medium described herein, a transport block size may be associated with the first modulation scheme and the second modulation scheme.

In some examples of the method, second wireless devices, and non-transitory computer-readable medium described herein, the first modulation scheme may be a first modulation and coding scheme (MCS), the second modulation scheme may be a second MCS different from the first MCS, the first data symbol may be encoded with the first MCS, and the second data symbol may be encoded with the second MCS.

Some examples of the method, second wireless devices, and non-transitory computer-readable medium described herein may further include operations, features, means, or instructions for transmitting, via the channel to the first wireless device, a third data symbol that may be a second virtual pilot symbol with a third MCS, where the third MCS may be equal to, or different from, the first MCS.

Some examples of the method, second wireless devices, and non-transitory computer-readable medium described herein may further include operations, features, means, or instructions for communicating, with the first wireless device, an indication of a configuration of the first modulation scheme for the first data symbol that may be the first virtual pilot symbol.

Details of one or more implementations of the subject matter described in this disclosure are set forth in the accompanying drawings and the description below. Other features, aspects, and enhancements will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports data bearing virtual pilots in accordance with one or more aspects of the present disclosure.

FIG. 2 shows an example of a wireless communications system that supports data bearing virtual pilots in accordance with one or more aspects of the present disclosure.

FIG. 3 shows an example of a timing diagram that supports data bearing virtual pilots in accordance with one or more aspects of the present disclosure.

FIG. 4 shows an example of a timing diagram that supports data bearing virtual pilots in accordance with one or more aspects of the present disclosure.

FIG. 5 shows an example of a timing diagram that supports data bearing virtual pilots in accordance with one or more aspects of the present disclosure.

FIG. 6 shows an example of a process flow that supports data bearing virtual pilots in accordance with one or more aspects of the present disclosure.

FIGS. 7 and 8 show block diagrams of devices that support data bearing virtual pilots in accordance with one or more aspects of the present disclosure.

FIG. 9 shows a block diagram of a communications manager that supports data bearing virtual pilots in accordance with one or more aspects of the present disclosure.

FIG. 10 shows a diagram of a system including a device that supports data bearing virtual pilots in accordance with one or more aspects of the present disclosure.

FIGS. 11 and 12 show block diagrams of devices that support data bearing virtual pilots in accordance with one or more aspects of the present disclosure.

FIG. 13 shows a block diagram of a communications manager that supports data bearing virtual pilots in accordance with one or more aspects of the present disclosure.

FIG. 14 shows a diagram of a system including a device that supports data bearing virtual pilots in accordance with one or more aspects of the present disclosure.

FIGS. 15 through 18 show flowcharts illustrating methods that support data bearing virtual pilots in accordance with one or more aspects of the present disclosure.

### DETAILED DESCRIPTION

Some wireless communication systems utilize reference signals to characterize a channel to aid in data symbol demodulation and decoding. For instance, a user equipment (UE) may receive a demodulation reference signal (DMRS) from a network entity, and may utilize the DMRS to demodulate or decode one or more data symbols. Reference signaling may consume communication resources. Data aided channel estimation may be utilized to reduce reference signal (e.g., DMRS) overhead and improve channel estimation quality for a time-varying channel (e.g., a Doppler channel). For example, a data symbol may be received and utilized as a virtual pilot symbol, which may allow data communication while enabling continued characterization of the channel.

In some approaches, the virtual pilots may be reconstructed from data resource elements (REs) of a channel (e.g., REs from a physical uplink shared channel (PUSCH) or a physical downlink shared channel (PDSCH)). The virtual pilot has the same modulation order or modulation and coding scheme (MCS) as shared channel data REs. Accordingly, the virtual pilot has the same level of reliability as the data of the shared channel. For virtual pilot reconstruction based on log likelihood ratios (LLRs), the virtual pilot reconstruction may fail if LLR errors occur or if code block decoding fails. For example, when the virtual pilot has the same degree of reliability as the remaining data REs, the receiver may experience an issue where poor virtual pilot reconstruction may result in a code block decoding error. Successful shared channel code block decoding may demand relatively good channel estimation at the receiver.

In some examples, a first wireless device may receive, in a slot and via a channel from a second wireless device, a first data symbol that is a first virtual pilot symbol with a first modulation scheme. The first wireless device may receive, in the slot and via the channel from the second wireless device, a second data symbol with a second modulation scheme, where the first modulation scheme is different from the second modulation scheme. The first wireless device may decode the second data symbol in association with a first estimate of the channel from the first virtual pilot symbol with the first modulation scheme.

By receiving a virtual pilot symbol that has a different modulation scheme may enable extra protection for the virtual pilot symbol, which may be utilized to ensure relatively good channel estimation quality or improved channel estimation quality. Receiving a virtual pilot symbol with a modulation scheme that is different from data may enable increased protection on the dedicated virtual pilot symbol relative to other data symbols. For instance, the modulation order or MCS for one or more virtual pilot symbols may be different from the modulation order or MCS for other data symbols. In some examples, the modulation order for the one or more virtual pilot symbols may be lower than the modulation order for the other data symbols. Additionally, or alternatively, the MCS for one or more virtual pilot symbols may differ from the MCS for the other data symbols. The virtual pilot symbols may utilize different settings for demodulation or decoding.

In some examples, the first wireless device may communicate, with the second wireless device, an indication of a location of the first data symbol that is the first virtual pilot symbol. By signaling the indication of the location (e.g., transmitting, from a network entity to a UE to indicate the location of the virtual pilot(s)) may enable flexibility in which resource(s) (e.g., symbol(s)) is utilized for a virtual pilot symbol(s).

Aspects of the disclosure are initially described in the context of wireless communications systems. Aspects of the disclosure are also described in the context of timing diagrams. Aspects of the disclosure are additionally described in the context of a process flow diagram. Aspects of the disclosure are further illustrated by and described with reference to apparatus diagrams, system diagrams, and flowcharts that relate to data bearing virtual pilots.

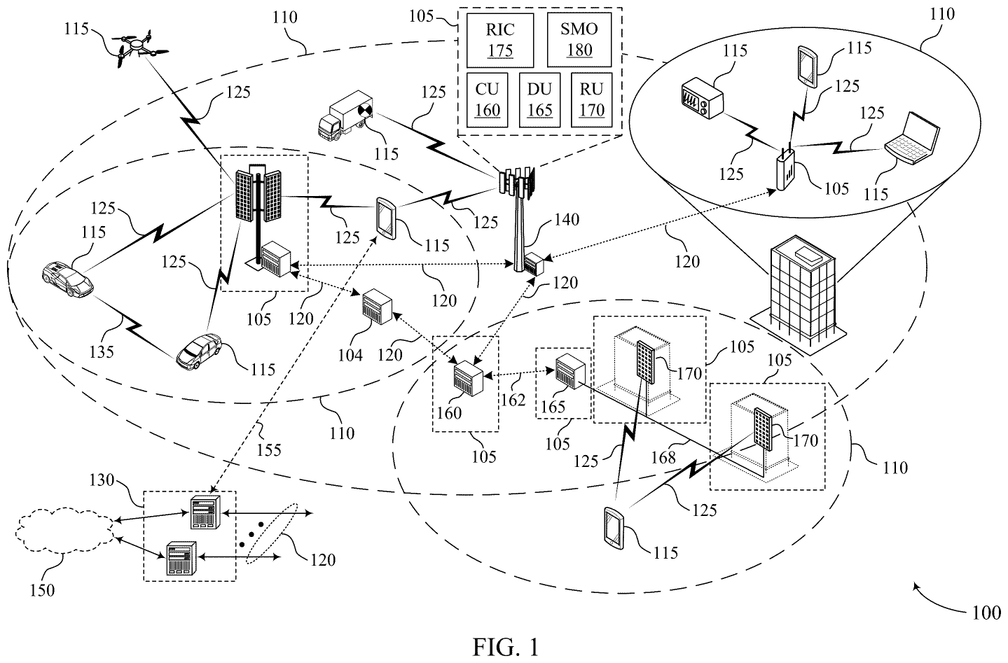

FIG. 1 shows an example of a wireless communications system 100 that supports data bearing virtual pilots in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems utilize reference signals to characterize a channel to aid in data symbol demodulation and decoding. For instance, a UE 115 may receive a DMRS from a network entity 105, and may utilize the DMRS to demodulate or decode one or more data symbols. Reference signaling may consume communication resources. Data aided channel estimation may be utilized to reduce reference signal (e.g., DMRS) overhead and improve channel estimation quality for a time-varying channel (e.g., a Doppler channel). For example, a data symbol may be received and utilized as a virtual pilot symbol, which may allow data communication while enabling continued characterization of the channel.

In some approaches, the virtual pilots may be reconstructed from data REs of a channel (e.g., REs from a PUSCH or a PDSCH). The virtual pilot has the same modulation order or MCS as shared channel data REs. Accordingly, the virtual pilot has the same level of reliability as the data of the shared channel. For virtual pilot reconstruction based on LLRs, the virtual pilot reconstruction may fail if LLR errors occur or if code block decoding fails. For example, when the virtual pilot has the same degree of reliability as the remaining data REs, the receiver may experience an issue where poor virtual pilot reconstruction may result in a code block decoding error. Successful shared channel code block decoding may demand relatively good channel estimation at the receiver.

Some examples may provide one or more data bearing virtual pilots with increased robustness. For instance, to reduce the DMRS overhead after a first DMRS, a shared channel (e.g., PUSCH or PDSCH) transmitter may insert a data bearing virtual pilot after the first DMRS to assist the channel estimation for a time varying channel. The modulation order of the virtual pilot may be lower than the data bearing REs to allow for increased virtual pilot reconstruction robustness (e.g., the accuracy of data symbol reconstruction for one or more virtual pilots may be more significant than that of data REs). For instance, if the channel estimation via the virtual pilot fails, the probability of successfully decoding data symbols in the data REs may be reduced.

In some examples, a first wireless device (e.g., a UE 115, a network entity 105, or another wireless device) may receive, in a slot and via a channel from a second wireless device (e.g., a UE 115, a network entity 105, or another wireless device), a first data symbol that is a first virtual pilot symbol with a first modulation scheme. The first wireless device may receive, in the slot and via the channel from the second wireless device, a second data symbol with a second modulation scheme, where the first modulation scheme is different from the second modulation scheme. The first wireless device may decode the second data symbol in association with a first estimate of the channel from the first virtual pilot symbol with the first modulation scheme.

By receiving a virtual pilot symbol that has a different modulation scheme may enable extra protection for the virtual pilot symbol, which may be utilized to ensure relatively good channel estimation quality or improved channel estimation quality. Receiving a virtual pilot symbol with a modulation scheme that is different from data may enable increased protection on the dedicated virtual pilot symbol relative to other data symbols. For instance, the modulation order or MCS for one or more virtual pilot symbols may be different from the modulation order or MCS for other data symbols. In some examples, the modulation order for the one or more virtual pilot symbols may be lower than the modulation order for the other data symbols. Additionally, or alternatively, the MCS for one or more virtual pilot symbols may differ from the MCS for the other data symbols. The virtual pilot symbols may utilize different settings for demodulation or decoding.

In some examples, the first wireless device may communicate, with the second wireless device, an indication of a location of the first data symbol that is the first virtual pilot symbol. By signaling the indication of the location (e.g., transmitting, from a network entity to a UE to indicate the location of the virtual pilot(s)) may enable flexibility in which resource(s) (e.g., symbol(s)) is utilized for a virtual pilot symbol(s). Some examples of the approaches described herein may be applicable to sixth generation (6G) devices or signaling (e.g., 6G PUSCH or PDSCH signaling).

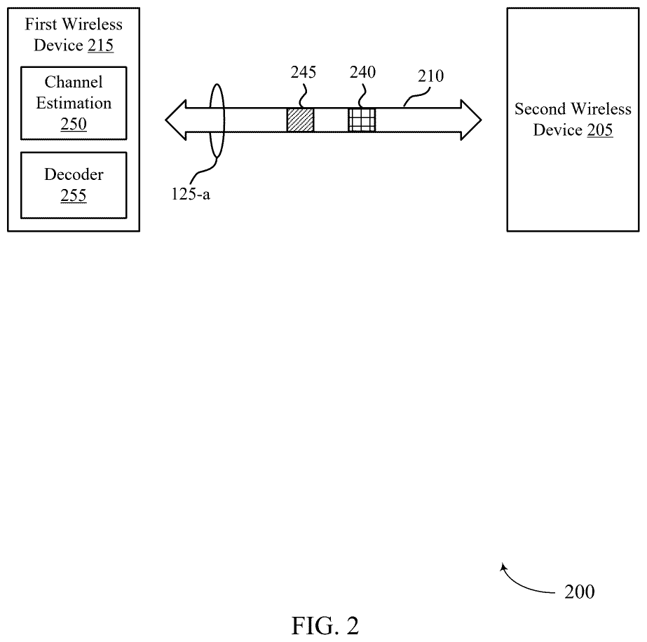

FIG. 2 shows an example of a wireless communications system 200 that supports data bearing virtual pilots in accordance with one or more aspects of the present disclosure. The wireless communications system 200 may implement aspects of or may be implemented by aspects of the wireless communications system 100. For example, the wireless communications system 200 includes a first wireless device 215, which may be an example of a UE 115 or a network entity 105 described with respect to FIG. 1. The wireless communications system 200 also includes a second wireless device 205, which may be an example of a network entity 105 or a UE 115 as described with respect to FIG. 1.

The first wireless device 215 may communicate with the second wireless device 205 using a link 125-a, which may be an example of a communication link 125 described with respect to FIG. 1. The link 125-a may include a unidirectional or bidirectional link that enables uplink or downlink communications. For example, the first wireless device 215 may transmit or receive one or more communications 210, such as uplink control signals or uplink data signals, to the second wireless device 205 using the link 125-a, or the second wireless device 205 may transmit or receive one or more communications 210, such as downlink control signals or downlink data signals, to the first wireless device 215 using the link 125-a. As used herein, the term “communicate,” and variations thereof, may mean to transmit, to receive, or a combination thereof.

The second wireless device 205 may transmit, or the first wireless device 215 may receive, in a slot and via a channel, a first data symbol 245 that is a first virtual pilot symbol with a first modulation scheme. As used herein, a “modulation scheme” may refer to a modulation order, a coding scheme, a code rate, an MCS, or a combination thereof.

For example, a modulation scheme may be a type of modulation (e.g., binary phase shift keying (BPSK), quadrature phase shift keying (QPSK), quadrature amplitude modulation (QAM), among other examples) or may be a modulation order (e.g., a modulation order of 2, 4, 8, 16, 64, 256, or 1024, among other examples), which may refer to a quantity of different symbols that can be represented or communicated via an associated modulation. A higher modulation order may be capable of representing a greater quantity of different symbols relative to a lower modulation order, while a lower modulation order may provide increased robustness relative to a higher modulation order. A coding scheme may refer to a code rate for forward error correction (FEC) coding, a type of coding, or a quantity of coding redundancy. A higher coding scheme (e.g., code rate) may be capable of representing information (e.g., bits) more efficiently (e.g., with greater spectral efficiency) relative to a lower coding scheme, while a lower coding scheme may provide increased robustness (e.g., increased redundancy) relative to a higher coding scheme. An MCS may refer to a combination of modulation and coding. A higher MCS may be capable of representing a greater quantity of information (e.g., bits or symbols) relative to a lower MCS, while a lower MCS may provide increased robustness relative to a higher MCS. Different MCSs may include different modulation types, different modulation orders, different coding types, different code rates, or a combination thereof. For instance, two different MCSs may include the same modulation order with different code rates, different modulation orders with a same code rate, or different modulation orders with different code rates.

The first data symbol 245 may be a symbol that indicates or includes modulated data (e.g., payload data), where the first data symbol 245 is also a first virtual pilot symbol that may be utilized for channel estimation. For instance, a virtual pilot symbol is a symbol that may indicate payload data, may indicate one or more channel characteristics (e.g., channel phase, frequency shift (such as Doppler shift), attenuation, fading, multipath, or a combination thereof), or may be associated with an indication or a configuration designating the symbol as a virtual pilot symbol. In some examples, a virtual pilot symbol may carry data (e.g., payload data) without a reference signal (e.g., without a DMRS or other reference signal) or pilot signal. For instance, a virtual pilot symbol may include (e.g., may only include) one or more data REs, or may be transmitted or received via one or more data REs. In some approaches, a virtual pilot symbol may be transmitted or received with an equal or lower modulation order or MCS than other data. The first wireless device 215 (or a device that receives a virtual pilot symbol) may utilize the virtual pilot symbol to perform channel estimation (after reconstructing data modulation symbols, for instance). In some approaches, a virtual pilot symbol may not carry an established (e.g., set or anticipated) signal or pattern. In some examples, a virtual pilot symbol (e.g., a channel estimate based on the virtual pilot symbol) may be utilized to receive (e.g., demodulate) data in a same period (e.g., slot) in which the virtual pilot symbol is received or in a different period (e.g., slot) from a slot in which the virtual pilot symbol is received. For instance, the first wireless device 215 may receive the virtual pilot symbol in a first slot, and may utilize a channel estimate from the virtual pilot symbol for demodulating data in the first slot or in a second slot after the first slot.

The first wireless device 215 may generate a channel estimate (e.g., a first estimate of the channel) in association with the first data symbol 245 (e.g., the virtual pilot symbol). For instance, the first wireless device 215 may include a channel estimation component 250 that may generate the channel estimate using the first data symbol 245.

In some approaches, the channel estimate (e.g., first estimate of the channel) may be determined in association with a reconstruction of the first virtual pilot symbol. For instance, the first wireless device 215 (e.g., channel estimation component 250) may reconstruct a symbol or modulation constellation (e.g., quadrature amplitude modulation (QAM) constellation) based on the first data symbol 245 (e.g., the virtual pilot symbol). In some aspects, the first wireless device 215 may perform virtual pilot reconstruction (e.g., QAM reconstruction) from a demapper. For instance, the first wireless device 215 may utilize the log likelihood ratios (LLRs) of a demapper to reconstruct the QAM constellation(s) for a symbol (e.g., the virtual pilot symbol). In some approaches, the first wireless device 215 may reconstruct a symbol after decoding the first data symbol 245. For instance, the first wireless device 215 may include a decoder 255, which may be utilized to decode the first data symbol 245. The first data symbol 245 may be decoded, where error correction in the channel coding or cyclic redundancy check (CRC) coding may be utilized to ensure that the reconstruction (e.g., constellation reconstruction) is correct.

In some approaches, the channel estimate may be determined in association with the reconstructed symbol(s) or modulation constellation. For instance, to perform channel estimation using one or more virtual symbols, the first wireless device 215 may multiply the reconstructed virtual pilot tone with frequency domain received signals to calculate the channel estimates. For instance, the first wireless device 215 may decode the first data symbol 245 and correlate the decoded first data symbol 245 with a received signal to determine a channel estimate. In some aspects, the first wireless device 215 (e.g., channel estimation component 250) may calculate the channel estimate (H) in association with the virtual pilot symbol (denoted “vp”) in accordance with Equation (1).

$${H}_{v p} = b \cdot {X}^{H} Y \qquad ( 1 )$$

In Equation (1), Hᵥₚ denotes a channel estimate from the virtual pilot symbol. Y denotes one or more frequency domain symbols (e.g., the virtual pilot symbol in the frequency domain), where Y may have dimensions of a quantity of REs×a quantity of received symbols. X denotes one or more reconstructed constellations, where X may have dimensions of a quantity of REs x a rank of the channel. The term b denotes a regularization factor.

The second wireless device 205 may transmit, or the first wireless device 215 may receive, in the slot and via the channel, a second data symbol 240 with a second modulation scheme. The first modulation scheme may be different from the second modulation scheme. For example, the first modulation scheme may be lower (e.g., lower in modulation order or code rate) than the second modulation scheme. The first modulation scheme may provide additional robustness for the first data symbol 245 (e.g., for the first virtual pilot symbol), which may enhance the accuracy of the first estimate of the channel that is based on the first data symbol 245.

The first wireless device 215 (e.g., the decoder 255) may decode the second data symbol 240 in association with the first estimate of the channel from the first virtual pilot symbol with the first modulation scheme. For instance, the first wireless device 215 may utilize the first estimate of the channel to compensate for channel distortion (e.g., attenuation, phase, Doppler shift, fading, multipath, or a combination thereof) in demodulating or decoding the second data symbol 240.

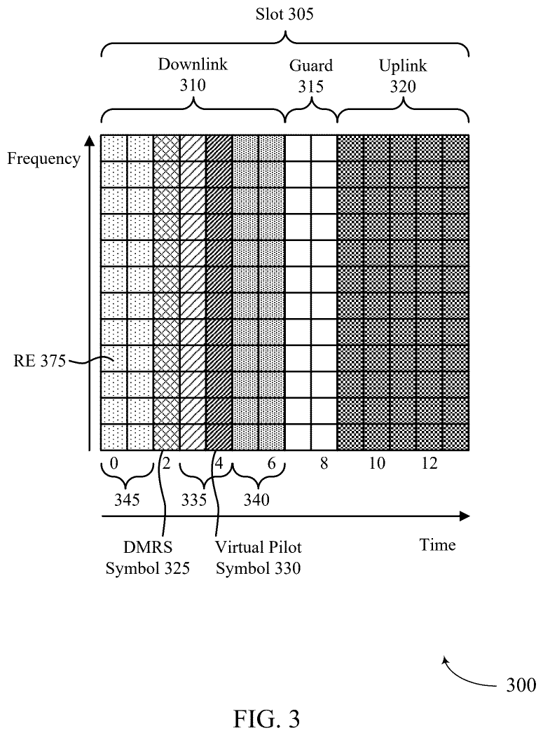

In some examples, the second wireless device 205 may transmit, or the first wireless device 215 may receive, via the channel, a first overhead symbol of a reference signal (not shown in FIG. 2). Examples of reference signals may include a DMRS, sounding reference signal (SRS), tracking reference signal (TRS), or other reference signal. For instance, the second wireless device 205 may transmit a DMRS symbol, SRS symbol, TRS symbol, or another reference signal to the first wireless device 215. The first overhead symbol of a reference signal may be received in a previous slot or in the slot with the first data symbol 245 and the second data symbol 240. In some examples, the reconstruction of the first virtual pilot symbol may be performed in association with a second estimate of the channel from the reference signal. For instance, the first wireless device 215 (e.g., the channel estimation component 250) may utilize the first overhead symbol of the reference signal to generate the second estimate of the channel. In some aspects, the first overhead symbol may be communicated before the first data symbol 245 or the second data symbol 240. An example of the first overhead symbol is described with reference to FIG. 3.

In some approaches, the second wireless device 205 may transmit, or the first wireless device 215 may receive, via the channel, a third data symbol (not shown in FIG. 2) that is a second virtual pilot symbol with a third modulation scheme. The third modulation scheme may be equal to (e.g., the same as), or different from, the first modulation scheme. The third data symbol may be received before or after the first data symbol 245 in the slot. For multiple virtual pilot symbols, different virtual pilot symbols may have the same or different modulation schemes. In some aspects, an earlier virtual pilot symbol may be utilized for decoding more data symbols in a slot than a later virtual pilot symbol in the slot. Providing enhanced robustness for the earlier virtual pilot symbol(s) may increase performance. Accordingly, a lower modulation scheme (e.g., modulation order, code rate, or MCS, among other examples) may be utilized for an earlier virtual pilot symbol than for a later virtual pilot symbol in some approaches.

In some examples, utilizing different modulation schemes for different virtual pilot symbols may increase wireless device implementation complexity. Accordingly, the same modulation scheme (e.g., modulation order, code rate, or MCS, among other examples) may be utilized for multiple virtual pilot symbols (e.g., all virtual pilot symbols in a slot).

In some approaches, a transport block size may be associated with the first modulation scheme and the second modulation scheme. For instance, utilizing different modulation schemes for the first data symbol 245 (e.g., the virtual pilot symbol) relative to the second data symbol 240 may affect the transport block size for a channel (e.g., shared channel, PUSCH, or PDSCH, among other examples). In some aspects, the first wireless device 215 or the second wireless device 205 may calculate the transport block size. The transport block size calculation for the channel (e.g., shared channel, PUSCH, or PDSCH, among other examples) with a virtual pilot symbol includes virtual pilot symbol resources with potentially different modulation schemes.

For the transport block size calculation at the first wireless device 215 or the second wireless device 205, the virtual pilot resources may be included, while the modulation order may be different from one or more other REs (e.g., remaining PUSCH or PDSCH REs). A quantity of information bits may include two parts (e.g., one part may be utilized for a legacy PUSCH or a legacy PDSCH, and another part may be utilized for virtual pilots). In some aspects, the transport block size may be calculated in accordance with Equation (2).

$${N}_{info} = {N}_{RE , vp} \cdot R \cdot {Q}_{m , vp} \cdot v + {N}_{RE , PxSCH} \cdot R \cdot {Q}_{m , PxSCH} \cdot v \qquad ( 2 )$$

In Equation (2), N_{info} is the transport block size (in terms of information bits, for instance), N_{RE,vp} is a quantity of REs corresponding to one or more virtual pilot symbols, R is a code rate, Q_{m,vp} is a modulation order for the REs of the one or more virtual pilot symbols, N_{RE,PxSCH} is a quantity of REs corresponding to a PUSCH or PDSCH, Q_{m,PxSCH} is a modulation order for the remaining REs (of a PUSCH or PDSCH, for instance), and v is a quantity of layers (e.g., MIMO layers). In some examples, the code rate R may differ for the virtual pilot symbol(s) and the other REs (e.g., REs of a PUSCH or PDSCH).

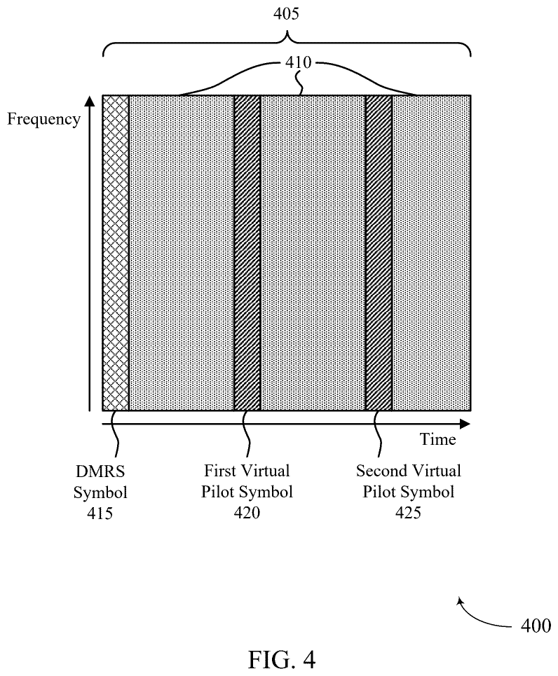

In some approaches, the first modulation scheme is a first MCS, and the second modulation scheme is a second MCS different from the first MCS. The first data symbol 245 may be encoded with the first MCS and the second data symbol may be encoded with the second MCS (by the second wireless device 205, for instance). In some examples, the second wireless device 205 may transmit, or the first wireless device 215 may receive, via the channel, a third data symbol (not shown in FIG. 2) that is a second virtual pilot symbol with a third MCS. The third MCS may be equal to (e.g., the same as), or different from, the first MCS. An example of virtual pilot symbols with same or different MCSs is given with reference to FIG. 4.

In some aspects, the first data symbol 245 may be encoded in a first code block with a first code rate, and the second data symbol 240 may be encoded separately from the first code block in a second code block with a second code rate (by the second wireless device 205, for instance). An example of virtual pilot symbols with same or different code rates is given with reference to FIG. 4.

In some examples, the first wireless device 215 or the second wireless device 205 may communicate an indication (not shown in FIG. 2) of a configuration of the first modulation scheme for the first data symbol 245 that is the first virtual pilot symbol. For instance, the first wireless device 215 may transmit the indication to the second wireless device 205, or the second wireless device 205 may transmit the indication to the first wireless device 215. For instance, the second wireless device 205 (e.g., a network entity or a transmitter) may configure the modulation scheme(s) (e.g., modulation order(s), coding scheme(s), or the MCS(s)) of the virtual pilot symbols via an RRC message or layer 1 (L1) signaling.

When a different modulation scheme (e.g., modulation order(s), coding scheme(s), or the MCS(s)) is utilized for virtual pilot symbols one or more approaches may be utilized. In some approaches, a modulation scheme for the virtual pilot symbol(s) may be configured via an RRC message. In some examples, the second wireless device 205 (e.g., a network entity or transmitter) may configure the modulation scheme of the virtual pilot symbol(s) semi-statically via an RRC message (e.g., as the channel condition for the link 125-a may be relatively stationary, for instance). In some approaches, L1 signaling may be utilized to signal the modulation scheme(s).

In some approaches, when different modulation schemes (e.g., modulation order(s), coding scheme(s), or the MCS(s)) are indicated for the virtual pilot symbol(s), communication (e.g., data transmission) efficiency may be a significant factor. In some aspects, a modulation scheme (e.g., MCS) for data (e.g., non-virtual pilot data, a PUSCH, or PDSCH, among other examples) may be configured dynamically. A modulation scheme for a code block on the virtual pilot symbol(s) may be configured dynamically in some approaches.

In some examples, the indication may be communicated (e.g., transmitted or received) in a first control information field (e.g., uplink control information (UCI) field or downlink control information (DCI) field) associated with the first virtual pilot symbol that is separate from a second control information field associated with the second data symbol 240. For instance, a separate control information field may be utilized to indicate the MCS for the virtual pilot symbol(s).

In some approaches, the indication of the modulation scheme for the first virtual pilot symbol may be an offset relative to a second modulation scheme (e.g., second MCS) associated with the second data symbol 240. For instance, the second wireless device 205 may transmit an indication that is a fixed offset(s) (e.g., MCS offset(s)) with respect to an indicated modulation scheme (e.g., MCS) for the PUSCH or PDSCH data REs (e.g., non-virtual pilot data REs). In some examples, the offset may be a global fixed MCS offset from an MCS for data REs to an MCS(s) for virtual pilot symbol(s) or one or more table based MCS offsets depending on the MCS of the data REs (e.g., non-virtual pilot data REs).

In some examples, a virtual pilot symbol(s) may be configured to utilize a same or different MCS table as the data REs. For robustness, the virtual pilot symbol(s) may be configured with an MCS table with a lower spectral efficiency (e.g., lower modulation order, lower code rate, or a combination thereof).

In some aspects, different modulation schemes (e.g., different modulation orders, code rates, or MCSs, among other examples) may be configured for different virtual pilot symbols at different locations (e.g., different locations within a PUSCH or PDSCH). Virtual pilots at different symbols (e.g., different symbols in a PUSCH or PDSCH transmission time interval (TTI) or slot) may utilize different levels of robustness.

In some approaches, the configuration may indicate or include one or more locations in time or frequency of the first data symbol 245 that is the first virtual pilot symbol. When one or more different modulation schemes (e.g., modulation orders, coding schemes, or MCSs, among other examples) are utilized for one or more virtual pilot symbols, the first wireless device 215 (e.g., receiver) or the second wireless device 205 (e.g., transmitter) may communicate an indication of the location of the virtual pilot symbol(s). In some examples, for a PUSCH or PDSCH, the first wireless device 215 (e.g., UE or receiver) or the second wireless device 205 (e.g., network entity or transmitter) may configure the frequency or time location(s) of the virtual pilot symbol(s).

For one or more time domain locations, the first wireless device 215, the second wireless device 205, or another wireless device (e.g., sidelink transmitter) may configure the symbol location (of a PUSCH or a PDSCH) via an RRC message. In some approaches, a table may be utilized where the symbol location(s) of the virtual pilot symbol(s) may depend on a PUSCH or PDSCH duration or configured virtual pilot position parameter(s) (e.g., VP-AdditionalPosition parameters). In some examples, one or more additional DMRS locations may utilize one or more additional position parameters.

For one or more frequency domain locations, the virtual pilot symbol(s) may have a same frequency span as an associated PUSCH or PDSCH. In some examples, the virtual pilot symbol(s) may not occupy each frequency tone (in a set of REs, for instance). In some approaches, one or more virtual pilot symbols may be communicated with a comb structure. The frequency separation between two consecutive virtual pilot tones or the comb offset may be configured via signaling (e.g., an RRC message).

FIG. 3 shows an example of a timing diagram 300 that supports data bearing virtual pilots in accordance with one or more aspects of the present disclosure. In particular, FIG. 3 illustrates an example of a slot 305 in which a virtual pilot symbol 330 may be utilized. For instance, the first wireless device 215 or the second wireless device 205 described with reference to FIG. 2 may transmit or receive symbols in the slot 305. The timing diagram 300 is illustrated in frequency over time (in symbols). The blocks in the diagram may represent REs 375.

In the example of FIG. 3, the slot 305 is a “special” slot, which includes a downlink portion 310, a guard portion 315, and an uplink portion 320. The uplink portion 320 includes five uplink symbols (e.g., for a PUSCH). The guard portion 315 occupies two symbol periods. In some examples, no communications may be scheduled for the guard portion 315 to allow the wireless device(s) to switch from downlink to uplink.

The downlink portion 310 includes a DMRS symbol 325, first downlink data symbols 335, downlink second data symbols 340, and other symbols 345. The DMRS symbol 325 may be an example of the first overhead symbol of a reference signal described with reference to FIG. 2. The first downlink data symbols 335 may include a virtual pilot symbol 330. The virtual pilot symbol 330 may be an example of the first data symbol 245 that is a virtual pilot symbol as described with reference to FIG. 2. One or more of the second data symbols 340 may be examples of the second data symbol 240 described with reference to FIG. 2.

In the example of FIG. 3, the slot 305 is a special slot that includes one front loaded DMRS symbol 325. In some examples, a wireless device (e.g., the first wireless device 215 or receiver) may perform channel estimation from the DMRS symbol 325 at symbol 2 to obtain an estimate of the channel. The wireless device may reconstruct the modulation symbol(s) (e.g., QAM modulation symbol(s)) in symbol 4 as one or more virtual pilot tones as described with reference to FIG. 2 (utilizing the estimate of the channel from the DMRS symbol 325 at symbol 2).

After performing virtual pilot reconstruction (e.g., QAM constellation reconstruction), the wireless device may have a virtual pilot tone in symbol 4 (similar to the DMRS tone from symbol 2). The virtual pilot tone may be utilized to interpolate the channel for one or more later symbols (e.g., PDSCH symbols 5 and 6). For example, the second data symbols 340 may be demodulated or decoded using data aided channel estimation (DACE). While the example of FIG. 3 is described in terms of downlink data symbols, a similar approach may be utilized to interpolate the channel for one or more uplink symbols (e.g., PUSCH) symbols.

In some approaches, the virtual pilot symbol 330 may have a different modulation scheme (e.g., modulation order, coding scheme, code rate, or MCS, among other examples) than the modulation scheme of the second data symbols 340. For instance, the virtual pilot symbol 330 may have a lower modulation scheme (e.g., lower modulation order, coding scheme, code rate, MCS, or combination thereof) than the modulation scheme of the second data symbols 340. The different (e.g., lower) modulation scheme of the virtual pilot symbol 330 may ensure greater accuracy in channel estimation, which may increase the decoding accuracy of the second data symbols 340.

FIG. 4 shows an example of a timing diagram 400 that supports data bearing virtual pilots in accordance with one or more aspects of the present disclosure. The timing diagram 400 illustrates an example of data bearing virtual pilots with one or more different modulation schemes (e.g., different modulation orders, coding schemes, code rates, or MCSs, among other examples). In particular, FIG. 4 illustrates an example of a slot 405 in which a first virtual pilot symbol 420 or a second virtual pilot symbol 425 may be utilized. For instance, the first wireless device 215 or the second wireless device 205 described with reference to FIG. 2 may transmit or receive symbols in the slot 405. The timing diagram 400 is illustrated in frequency over time (in symbols).

In the example of FIG. 4, the slot 405 includes a DMRS symbol 415, data portions 410, the first virtual pilot symbol 420, and the second virtual pilot symbol 425. The DMRS symbol 415 may be an example of the first overhead symbol of a reference signal described with reference to FIG. 2. The first virtual pilot symbol 420 and the second virtual pilot symbol 425 may be examples of the first data symbol 245 that is a virtual pilot symbol as described with reference to FIG. 2. One or more symbols of the data portions 410 may be examples of the second data symbol 240 described with reference to FIG. 2. The data portions 410, the first virtual pilot symbol 420, and the second virtual pilot symbol 425 may carry data (e.g., payload data). In some examples, the data portions 410 may be, or may include, data REs (associated with one or more PUSCHs or one or more PDSCHs, for instance). Additionally, or alternatively, the data portions 410 may be one or more code blocks (e.g., respective code blocks associated with one or more PUSCHs or one or more PDSCHs). In some aspects, a channel estimate from the DMRS symbol 415 may be utilized to demodulate or decode the data portions 410 after the DMRS symbol 415. A channel estimate from the first virtual pilot symbol 420 (and from the DMRS symbol 415) may be utilized to demodulate or decode the data portions 410 after the first virtual pilot symbol 420. A channel estimate from the second virtual pilot symbol 425 (and from the first virtual pilot symbol 420 and the DMRS symbol 415) may be utilized to demodulate or decode the data portion 410 after the second virtual pilot symbol 425.

In some examples, the first virtual pilot symbol 420 or the second virtual pilot symbol 425 may have one or more modulation orders that are lower than a modulation order of the data portions 410. For instance, the first virtual pilot symbol 420 or the second virtual pilot symbol 425 may be modulated using QPSK, while the data portions 410 (e.g., PUSCH or PDSCH data REs) may be modulated using 256 QAM.

In some examples, a second wireless device (e.g., the second wireless device 205, a transmitter, a PUSCH transmitter, a PDSCH transmitter, a network entity, a UE, or another wireless device) may generate (e.g., insert) data bearing virtual pilots (e.g., the first virtual pilot symbol 420 or the second virtual pilot symbol 425) with a different modulation order to improve the robustness of virtual pilot reconstruction. For example, a first wireless device (e.g., the first wireless device 215, a receiver, a PUSCH receiver, a PDSCH receiver, a network entity, a UE, or another wireless device) that receives the first virtual pilot symbol 420 or the second virtual pilot symbol 425 may utilize the data bearing virtual pilots for virtual pilot reconstruction. In some aspects, the first wireless device may include a demapper that is more robust in decoding LLRs (e.g., for QAM constellation reconstruction) with a relatively lower modulation order. Accordingly, utilizing a first virtual pilot symbol 420 or a second virtual pilot symbol 425 with a lower modulation order may increase the accuracy of the reconstructed modulation symbol(s) of the first virtual pilot symbol 420 or the second virtual pilot symbol 425, which may improve accuracy in channel estimation.

Utilizing a lower modulation order for virtual pilots may result in increased overhead for communication (e.g., PUSCH or PDSCH transmission). Accordingly, the second wireless device (e.g., the second wireless device 205 or a network entity, among other examples) may control a tradeoff between channel estimation performance and the virtual pilot overhead by selecting one or more modulation orders for the data bearing virtual pilots (e.g., the first virtual pilot symbol 420 or the second virtual pilot symbol 425). In some aspects, a same code rate may be utilized on the data portions 410 (e.g., PUSCH or PDSCH data REs) and resources for the first virtual pilot symbol 420 or the second virtual pilot symbol 425. In some approaches, a code block may be rate matched to the data portions 410 (e.g., PUSCH or PDSCH data REs) and the first virtual pilot symbol 420 and the second virtual pilot symbol 425 (e.g., virtual pilot REs), except that the modulation (e.g., QAM) mapping or modulation order may be different.

In some examples, the first virtual pilot symbol 420 or the second virtual pilot symbol 425 may have one or more MCSs that are lower than an MCS of the data portions 410. For instance, the first virtual pilot symbol 420 or the second virtual pilot symbol 425 may be modulated and coded using MCS17 with a spectral efficiency of 2.56, while the data portions 410 (e.g., PUSCH or PDSCH data REs) may be modulated and coded using MCS25 with a spectral efficiency of 4.82.

In some examples, a first wireless device (e.g., the first wireless device 215, a receiver, a PUSCH receiver, a PDSCH receiver, a network entity, a UE, or another wireless device) may reconstruct virtual pilots after decoding. For instance, the first wireless device may support different MCSs on virtual pilots. A second wireless device (e.g., the second wireless device 205, a transmitter, a PUSCH transmitter, a PDSCH transmitter, a network entity, a UE, or another wireless device) may generate (e.g., insert) data bearing virtual pilots (e.g., the first virtual pilot symbol 420 or the second virtual pilot symbol 425) with different MCS(s) to improve the robustness of virtual pilot reconstruction.

The second wireless device (e.g., the second wireless device 205, a transmitter, a PUSCH transmitter, a PDSCH transmitter, a network entity, a UE, or another wireless device) may encode (e.g., perform PUSCH or PDSCH encoding for) the information bits of data bearing virtual pilots (e.g., the first virtual pilot symbol 420 or the second virtual pilot symbol 425) independently from other data (e.g., data portions 410 or remaining PUSCH or PDSCH data REs). A first wireless device (e.g., the first wireless device 215, a receiver, a PUSCH receiver, a PDSCH receiver, a network entity, a UE, or another wireless device) may perform virtual pilot reconstruction after channel decoding. In some aspects, a different MCS may be utilized for virtual pilots (e.g., the first virtual pilot symbol 420 or the second virtual pilot symbol 425), which may provide a different (e.g., increased) level of protection. Enabling utilization of different MCSs may provide increased granularity for the second wireless device to tune virtual pilot overhead consumption. For instance, the second wireless device may control virtual pilot overhead by selecting the MCS(s) of the first virtual pilot symbol 420 or the second virtual pilot symbol 425. In some cases, utilizing different modulation orders may incur a rate loss. Utilizing different MCSs may enable increased control of a tradeoff between robustness and rate loss.

In some approaches where one or more data bearing virtual pilots (e.g., PUSCH or PDSCH on virtual pilots) are transmitted with one or more lower MCSs, separate code blocks or transport blocks (TBs) may be encoded independently. For multiple virtual pilot symbols, different virtual pilot symbols (e.g., the first virtual pilot symbol 420 and the second virtual pilot symbol 425) may have different MCSs. In some aspects, the earlier virtual pilot symbol may have a greater impact on virtual pilot reconstruction, channel estimation, or decoding than one or more later virtual pilot symbols in a slot. In some examples, a lower MCS may be utilized for an earlier virtual pilot symbol. For instance, the first virtual pilot symbol 420 may have a lower MCS than the second virtual pilot symbol 425. Using different MCSs between virtual pilot symbols may increase receive-side complexity. In some examples, a single MCS for all virtual pilots (e.g., the first virtual pilot symbol 420 and the second virtual pilot symbol 425) may be utilized, or different MCSs may be utilized for different virtual pilot symbols (e.g., the first virtual pilot symbol 420 and the second virtual pilot symbol 425).

To support different MCSs between virtual pilot symbols, separate channel encoding, channel decoding, or rate matching may be utilized. In some aspects, one or more separate code blocks may be utilized for virtual pilot resources. For example, the first virtual pilot symbol 420 or the second virtual pilot symbol 425 may be encoded in one or more code blocks, where the one or more code blocks have a lower code rate or rates than one or more code blocks of the data portion 410 (e.g., one or more code blocks of one or more PUSCHs or PDSCHs of the data portion 410).

In some approaches, to support different MCSs on virtual pilots, one or more separate code blocks may be encoded, rate matched, or communicated (e.g., transmitted or received) via virtual pilot resources. Separately encoding, rate matching, or communicating one or more code blocks may allow information bits (e.g., the data portion 410, PUSCH information bits, or PDSCH information bits, among other examples) to be transmitted at a different code rate than the code rate of virtual pilot resources (e.g., of the first virtual pilot symbol 420 or the second virtual pilot symbol 425). At the first wireless device (e.g., a decoder 255 of the first wireless device 215), the code block(s) communicated in virtual pilot resources (e.g., one or more code blocks with a lower code rate(s)) may be decoded independently to help ensure robust virtual pilot reconstruction.

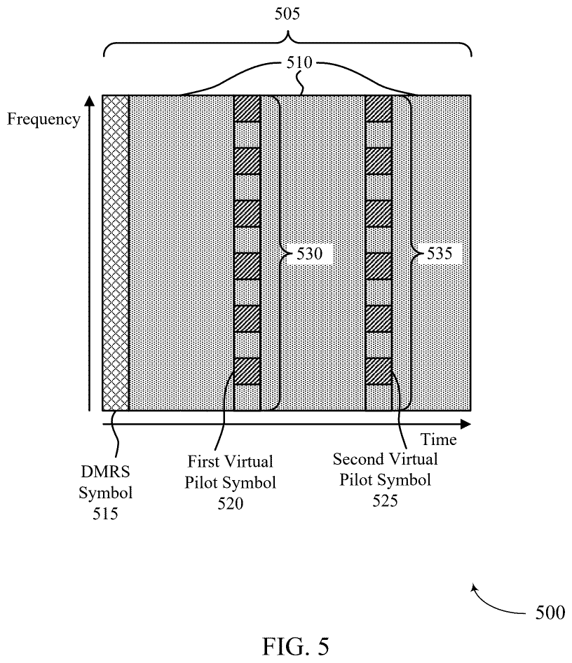

FIG. 5 shows an example of a timing diagram 500 that supports data bearing virtual pilots in accordance with one or more aspects of the present disclosure. The timing diagram 500 illustrates an example of data bearing virtual pilots with one or more different modulation schemes (e.g., different modulation orders, coding schemes, code rates, or MCSs, among other examples). In particular, FIG. 5 illustrates an example of a slot 505 in which a first virtual pilot symbol 520 or a second virtual pilot symbol 525 may be utilized. For instance, the first wireless device 215 or the second wireless device 205 described with reference to FIG. 2 may transmit or receive symbols in the slot 505. The timing diagram 500 is illustrated in frequency over time (in symbols).

In the example of FIG. 5, the slot 505 includes a DMRS symbol 515, data portions 510, the first virtual pilot symbol 520, and the second virtual pilot symbol 525. The DMRS symbol 515 may be an example of the first overhead symbol of a reference signal described with reference to FIG. 2. The first virtual pilot symbol 520 and the second virtual pilot symbol 525 may be examples of the first data symbol 245 that is a virtual pilot symbol as described with reference to FIG. 2. One or more symbols of the data portions 510 may be examples of the second data symbol 240 described with reference to FIG. 2. The data portions 510, the first virtual pilot symbol 520, and the second virtual pilot symbol 525 may carry data (e.g., payload data). In some examples, the data portions 510 may be, or may include, data REs (associated with one or more PUSCHs or one or more PDSCHs, for instance). Additionally, or alternatively, the data portions 510 may be one or more code blocks (e.g., respective code blocks associated with one or more PUSCHs or one or more PDSCHs). The first virtual pilot symbol 520 or the second virtual pilot symbol 525 may have one or more modulation schemes (e.g., modulation order, coding scheme, code rate, or MCS, among other examples) that are lower than a modulation scheme of the data portions 510.

In some approaches, the first virtual pilot symbol 520 may be communicated with a first comb structure 530 or the second virtual pilot symbol 525 may be communicated with a second comb structure 535. In a comb structure, a virtual pilot symbol may occupy portions (e.g., alternating portions) of symbol resources. For instance, pilot tones of the first virtual pilot symbol 520 may occupy portions of symbol resources (e.g., some REs), while other portions of symbol resources may be utilized for data without being utilized for a virtual pilot tone. The frequency separation between two consecutive virtual pilot tones or the comb offset of the first comb structure 530 or the second comb structure 535 may be configured via signaling (e.g., an RRC message).

In some approaches where one or more data bearing virtual pilots (e.g., PUSCH or PDSCH on virtual pilots) are transmitted with one or more lower MCSs, separate code blocks or TBs may be encoded independently. For instance, separate channel encoding, channel decoding, or rate matching may be utilized. In some aspects, one or more separate code blocks may be utilized for virtual pilot resources. For example, the first virtual pilot symbol 520 or the second virtual pilot symbol 525 may be encoded in one or more code blocks, where the one or more code blocks have a lower code rate or rates than one or more code blocks of the data portion 510 (e.g., one or more code blocks of one or more PUSCHs or PDSCHs of the data portion 510).

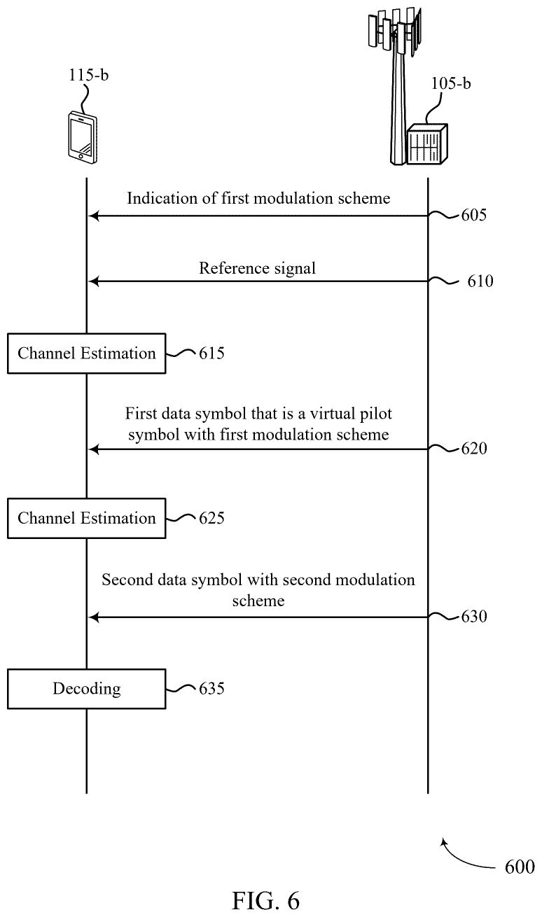

FIG. 6 shows an example of a process flow 600 that supports data bearing virtual pilots in accordance with one or more aspects of the present disclosure. A wireless communication system may include a UE 115-b and a network entity 105-b. The UE 115-b may be an example of the UEs 115, the first wireless device 215, or the second wireless device 205, or the network entity 105-b may be an example of the network entities 105, the second wireless device 205, or the first wireless device 215, as described herein.

In the following description of the process flow 600, the communications between the network entity 105-b and the UE 115-b may be transmitted in a different order than the example order shown, or the operations performed by the network entity 105-b and the UE 115-b may be performed in different orders or at different times. One or more operations may be omitted from the process flow 600, or one or more other operations may be added to the process flow 600. Although some operations or signaling may be shown to occur at different times for discussion purposes, these operations may actually occur at the same time or in overlapping time periods in some examples.

At 605, the network entity 105-b may output (e.g., transmit) an indication of a first modulation scheme to the UE 115-b. For example, the network entity 105-b may transmit, or the UE 115-b may receive, an indication of a modulation scheme, modulation order, coding scheme, code rate, or MCS for one or more virtual pilot symbols as described with reference to FIG. 2. In some approaches, the indication may be communicated via an RRC message, L1 signaling, or other signaling. In some aspects, the network entity 105-b may output (e.g., transmit) an indication of a configuration for virtual pilot symbols. In some examples, the indication of the configuration may instruct (e.g., configure) the UE 115-b to utilize one or more virtual pilot symbols. Additionally, or alternatively, the indication of the configuration may provide an indication of a location(s) of the virtual pilot symbol(s) (e.g., symbol number(s), an index of a slot configuration, an offset from another symbol, or other indication), the indication of a modulation scheme(s) (e.g., modulation order, coding scheme, code rate, or MCS, an offset from a data symbol modulation scheme, among other examples), or another parameter(s) for utilizing virtual pilot signaling.

In some examples, the UE 115-b may transmit capability signaling indicating that the UE 115-b is capable of utilizing one or more virtual pilot symbols, one or more modulation schemes for a virtual pilot symbol(s), one or more modulation orders for a virtual pilot symbol(s), one or more coding schemes for a virtual pilot symbol(s), one or more code rates for a virtual pilot symbol(s), one or more MCSs for a virtual pilot symbol(s), or one or more code structures (e.g., separate code block(s)) for a virtual pilot symbol(s), among other examples. In some aspects, the indication of the first modulation scheme may be transmitted or received in response to the capability signaling or the indication of the configuration.

At 610, the network entity 105-b may output (e.g., transmit) one or more reference signals to the UE 115-b. In some examples, the reference signal(s) may be a DMRS(s), TRS(s), SRS(s), or another reference signal(s). For instance, the network entity 105-b may transmit, or the UE 115-b may receive, one or more reference signals for generating one or more channel estimates using the one or more reference signals as described with reference to FIG. 2.

At 615, the UE 115-b may perform channel estimation based on the one or more reference signals. For example, the reference signal (e.g., DMRS) may have one or more established characteristics. The UE 115-b may store a representation of the established reference signal. The UE 115-b may compare the established reference signal with the received reference signal to determine the channel estimate. For instance, the UE 115-b may determine one or more channel characteristics (e.g., channel phase, frequency shift (such as Doppler shift), attenuation, fading, multipath, or a combination thereof) based on the comparison (e.g., transfer function calculation) of the established reference signal and the received reference signal. The resulting channel estimate may indicate one or more channel characteristics. In some examples, the UE 115-b may perform channel estimation as described with reference to one or more of FIGS. 2-5.

At 620, the network entity 105-b may output (e.g., transmit), or the UE 115-b may receive, a first data symbol that is a virtual pilot symbol with a first modulation scheme. For example, the network entity 105-b may generate and transmit the first data symbol using a first modulation scheme (e.g., modulation order, coding scheme, code rate, MCS, or a combination thereof, among other examples). The first data symbol that is a first virtual pilot symbol may be communicated in a slot with the reference signal, or in a slot after the reference signal. In some approaches, the network entity 105-b may transmit, or the UE 115-b may receive, the first data symbol that is a virtual pilot symbol as described with reference to one or more of FIGS. 2-5.

At 625, the UE 115-b may perform channel estimation in association with the first data symbol that is a virtual pilot symbol. For instance, the UE 115-b may determine (e.g., calculate) a channel estimate utilizing the virtual pilot symbol. In some approaches, the channel estimate (e.g., an estimate of the channel) may be determined in association with a reconstruction of the first virtual pilot symbol. For instance, the UE 115-b may reconstruct a symbol or modulation constellation (e.g., QAM constellation) based on the first data symbol (e.g., the virtual pilot symbol). In some examples, the UE 115-b may reconstruct the modulation constellation by determining a symbol (e.g., constellation point) nearest to the received first data symbol and determining one or more channel characteristics (e.g., phase rotation, frequency shift, or attenuation, among other examples) to account for a difference between the received first data symbol and the nearest symbol (e.g., constellation point) of the constellation. The constellation may be reconstructed by applying the channel characteristic(s) to other constellation points in a default modulation constellation (e.g., a modulation constellation without channel effects applied, such as without rotation or scaling). The channel characteristic(s) may correspond to the channel estimate.

In some aspects, the UE 115-b may perform virtual pilot reconstruction (e.g., modulation constellation reconstruction) from a demapper. For instance, the UE 115-b may utilize the LLRs of a demapper to reconstruct a modulation constellation for a symbol (e.g., the virtual pilot symbol). In some approaches, the UE 115-b may reconstruct a symbol after decoding the first data symbol. For instance, the UE 115-b may decode the first data symbol, where error correction in the channel coding or CRC may be utilized to ensure that the reconstruction (e.g., constellation reconstruction) is correct.

In some approaches, the channel estimate may be determined in association with the reconstructed symbol(s) or modulation constellation. For instance, to perform channel estimation using one or more virtual symbols, the UE 115-b may multiply the reconstructed virtual pilot tone with frequency domain received signals to calculate the channel estimates. In some aspects, the UE 115-b may calculate the channel estimate in accordance with Hᵥₚ=b·X^{H}Y as described with reference to FIG. 2.

In some examples, channel estimation of the first data symbol may be performed based on the channel estimate of the reference signal. For instance, the channel estimate of the reference signal may be utilized to decode the first data symbol, where the decoded first data symbol may be utilized to determine (e.g., calculate) the channel estimate of the first data symbol.

At 630, the network entity 105-b may output (e.g., transmit), or the UE 115-b may receive, a second data symbol with a second modulation scheme. The second modulation scheme may be a higher modulation scheme than the first modulation scheme. The first modulation scheme of the first data symbol may be relatively lower to increase the accuracy of the channel estimate that is produced from the first data symbol (e.g., first virtual pilot symbol).

At 635, the UE 115-b may perform decoding of the second data symbol. For example, the UE 115-b may utilize the channel estimate of the first data symbol, or another channel estimate (e.g., an interpolated channel estimate determined from the channel estimate of the first data symbol) to decode the second data symbol. For instance, the UE 115-b may reduce or remove the effect(s) (e.g., channel distortion) of the second data symbol using the channel estimate to demodulate, demap, or decode the second data symbol.

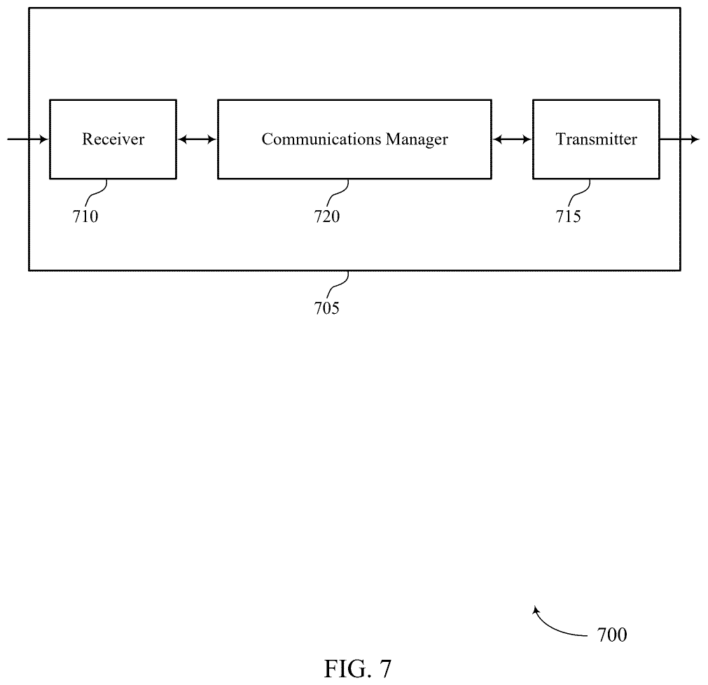

FIG. 7 shows a block diagram 700 of a device 705 that supports data bearing virtual pilots in accordance with one or more aspects of the present disclosure. The device 705 may be an example of aspects of a first wireless device as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to data bearing virtual pilots). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to data bearing virtual pilots). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of data bearing virtual pilots as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for receiving, in a slot and via a channel from a second wireless device, a first data symbol that is a first virtual pilot symbol with a first modulation scheme. The communications manager 720 is capable of, configured to, or operable to support a means for receiving, in the slot and via the channel from the second wireless device, a second data symbol with a second modulation scheme, where the first modulation scheme is different from the second modulation scheme. The communications manager 720 is capable of, configured to, or operable to support a means for decoding the second data symbol in association with a first estimate of the channel from the first virtual pilot symbol with the first modulation scheme.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

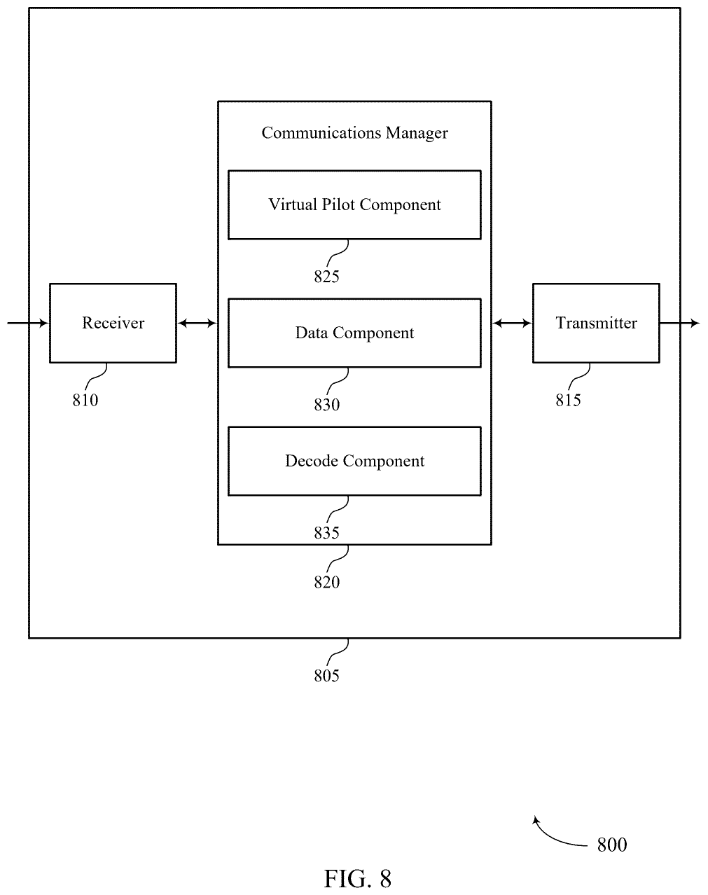

FIG. 8 shows a block diagram 800 of a device 805 that supports data bearing virtual pilots in accordance with one or more aspects of the present disclosure. The device 805 may be an example of aspects of a device 705, a first wireless device 215, a UE 115, or a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to data bearing virtual pilots). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to data bearing virtual pilots). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of data bearing virtual pilots as described herein. For example, the communications manager 820 may include a virtual pilot component 825, a data component 830, a decode component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The virtual pilot component 825 is capable of, configured to, or operable to support a means for receiving, in a slot and via a channel from a second wireless device, a first data symbol that is a first virtual pilot symbol with a first modulation scheme. The data component 830 is capable of, configured to, or operable to support a means for receiving, in the slot and via the channel from the second wireless device, a second data symbol with a second modulation scheme, where the first modulation scheme is different from the second modulation scheme. The decode component 835 is capable of, configured to, or operable to support a means for decoding the second data symbol in association with a first estimate of the channel from the first virtual pilot symbol with the first modulation scheme.

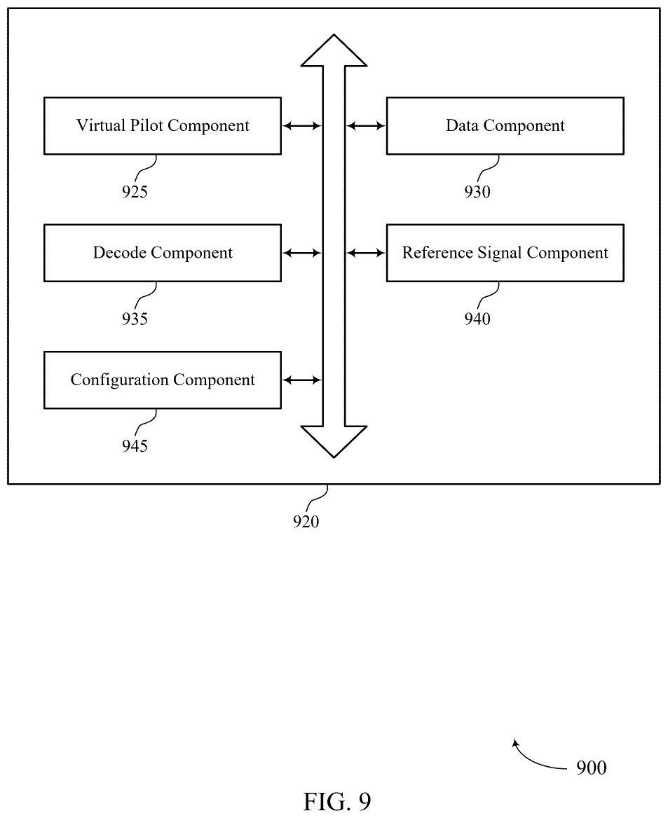

FIG. 9 shows a block diagram 900 of a communications manager 920 that supports data bearing virtual pilots in accordance with one or more aspects of the present disclosure. The communications manager 920 may be an example of aspects of a communications manager 720, a communications manager 820, or both, as described herein. The communications manager 920, or various components thereof, may be an example of means for performing various aspects of data bearing virtual pilots as described herein. For example, the communications manager 920 may include a virtual pilot component 925, a data component 930, a decode component 935, a reference signal component 940, a configuration component 945, or any combination thereof. Each of these components, or components or subcomponents thereof (e.g., one or more processors, one or more memories), may communicate, directly or indirectly, with one another (e.g., via one or more buses).

The virtual pilot component 925 is capable of, configured to, or operable to support a means for receiving, in a slot and via a channel from a second wireless device, a first data symbol that is a first virtual pilot symbol with a first modulation scheme. The data component 930 is capable of, configured to, or operable to support a means for receiving, in the slot and via the channel from the second wireless device, a second data symbol with a second modulation scheme, where the first modulation scheme is different from the second modulation scheme. The decode component 935 is capable of, configured to, or operable to support a means for decoding the second data symbol in association with a first estimate of the channel from the first virtual pilot symbol with the first modulation scheme.

In some examples, the reference signal component 940 is capable of, configured to, or operable to support a means for receiving, via the channel from the second wireless device, a first overhead symbol of a reference signal in the slot with the first data symbol and the second data symbol, where a reconstruction of the first virtual pilot symbol is performed in association with a second estimate of the channel from the reference signal.

In some examples, the first estimate of the channel is determined in association with the reconstruction of the first virtual pilot symbol.

In some examples, the virtual pilot component 925 is capable of, configured to, or operable to support a means for receiving, via the channel from the second wireless device, a third data symbol that is a second virtual pilot symbol with a third modulation scheme, where the third modulation scheme is equal to, or different from, the first modulation scheme.

In some examples, the third data symbol is received after the first data symbol in the slot.

In some examples, a transport block size is associated with the first modulation scheme and the second modulation scheme.

In some examples, the first modulation scheme is a first modulation and coding scheme (MCS), and the second modulation scheme is a second MCS different from the first MCS. In some examples, the first data symbol is encoded with the first MCS and the second data symbol is encoded with the second MCS.

In some examples, the virtual pilot component 925 is capable of, configured to, or operable to support a means for receiving, via the channel from the second wireless device, a third data symbol that is a second virtual pilot symbol with a third MCS, where the third MCS is equal to, or different from, the first MCS.

In some examples, the first data symbol is encoded in a first code block with a first code rate, and the second data symbol is encoded separately from the first code block in a second code block with a second code rate.

In some examples, the configuration component 945 is capable of, configured to, or operable to support a means for communicating, with the second wireless device, an indication of a configuration of the first modulation scheme for the first data symbol that is the first virtual pilot symbol.

In some examples, the indication is received in a first control information field associated with the first virtual pilot symbol that is separate from a second control information field associated with the second data symbol.

In some examples, the indication is an offset relative to a second MCS associated with the second data symbol.

In some examples, the configuration includes one or more locations in time or frequency of the first data symbol that is the first virtual pilot symbol.

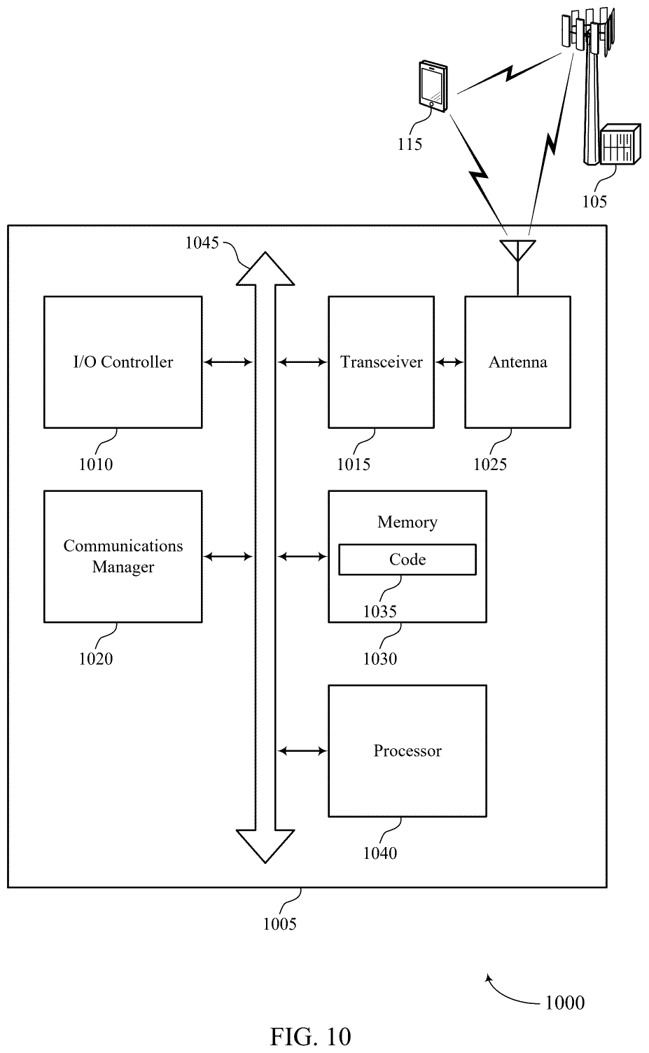

FIG. 10 shows a diagram of a system 1000 including a device 1005 that supports data bearing virtual pilots in accordance with one or more aspects of the present disclosure. The device 1005 may be an example of or include components of a device 705, a device 805, or a first wireless device as described herein. The device 1005 may include components for bi-directional voice and data communications including components for transmitting and receiving communications, such as a communications manager 1020, an I/O controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include RAM and ROM. The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a BIOS which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting data bearing virtual pilots). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

For example, the communications manager 1020 is capable of, configured to, or operable to support a means for receiving, in a slot and via a channel from a second wireless device, a first data symbol that is a first virtual pilot symbol with a first modulation scheme. The communications manager 1020 is capable of, configured to, or operable to support a means for receiving, in the slot and via the channel from the second wireless device, a second data symbol with a second modulation scheme, where the first modulation scheme is different from the second modulation scheme. The communications manager 1020 is capable of, configured to, or operable to support a means for decoding the second data symbol in association with a first estimate of the channel from the first virtual pilot symbol with the first modulation scheme.

By including or configuring the communications manager 1020 in accordance with examples as described herein, the device 1005 may support techniques for improved communication reliability, reduced latency, reduced power consumption, more efficient utilization of communication resources, improved coordination between devices, longer battery life, or improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of data bearing virtual pilots as described herein, or the at least one processor 1040 and the at least one memory 1030 may be otherwise configured to, individually or collectively, perform or support such operations.

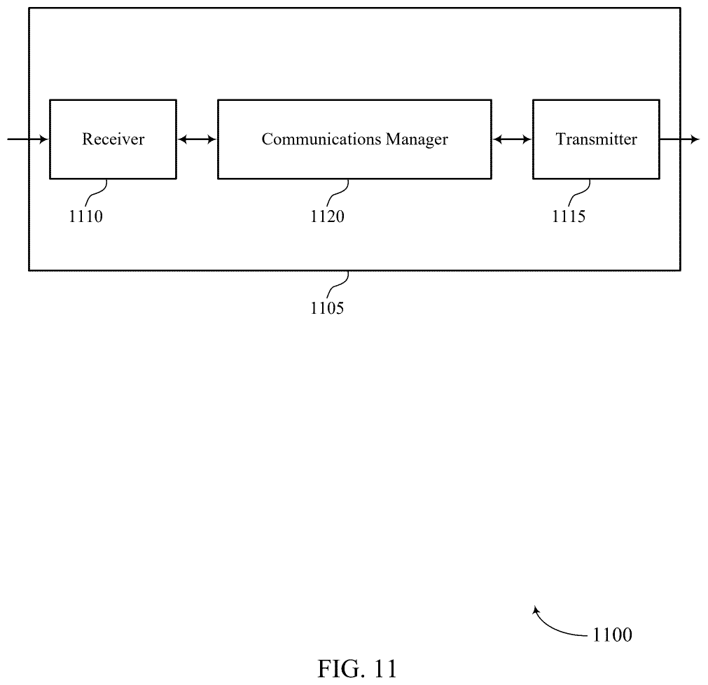

FIG. 11 shows a block diagram 1100 of a device 1105 that supports data bearing virtual pilots in accordance with one or more aspects of the present disclosure. The device 1105 may be an example of aspects of a second wireless device as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of data bearing virtual pilots as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

For example, the communications manager 1120 is capable of, configured to, or operable to support a means for transmitting, in a slot and via a channel to a first wireless device, a first overhead symbol of a reference signal for a reconstruction of a first virtual pilot symbol. The communications manager 1120 is capable of, configured to, or operable to support a means for transmitting, in the slot and via the channel to the first wireless device, a first data symbol that is the first virtual pilot symbol with a first modulation scheme. The communications manager 1120 is capable of, configured to, or operable to support a means for transmitting, in the slot to the first wireless device, a second data symbol with a second modulation scheme, where the first modulation scheme is different from the second modulation scheme.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, or more efficient utilization of communication resources.

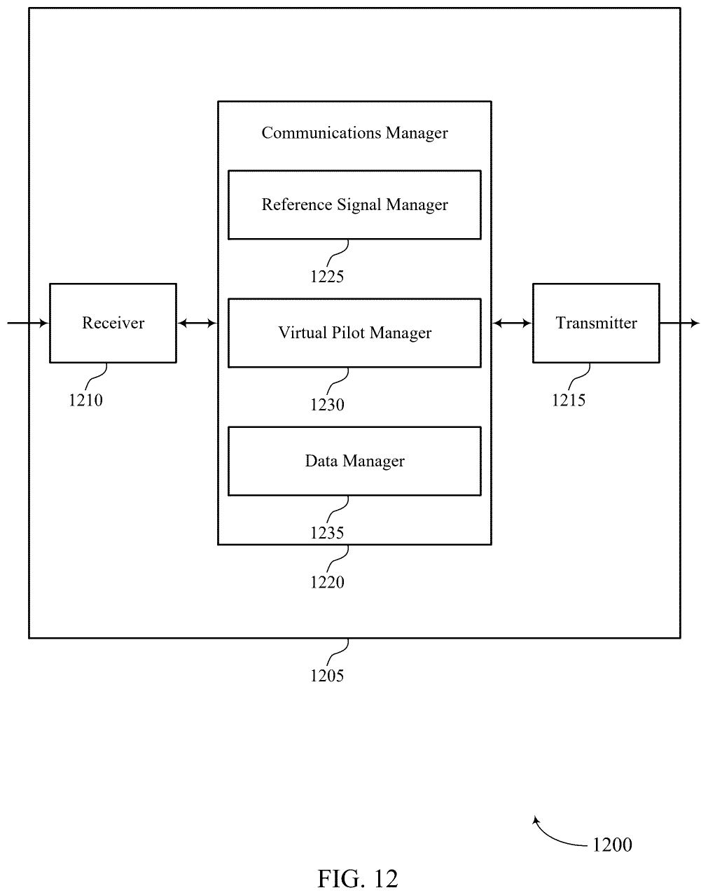

FIG. 12 shows a block diagram 1200 of a device 1205 that supports data bearing virtual pilots in accordance with one or more aspects of the present disclosure. The device 1205 may be an example of aspects of a device 1105, a second wireless device 205, a network entity 105, or a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of data bearing virtual pilots as described herein. For example, the communications manager 1220 may include a reference signal manager 1225, a virtual pilot manager 1230, a data manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The reference signal manager 1225 is capable of, configured to, or operable to support a means for transmitting, in a slot and via a channel to a first wireless device, a first overhead symbol of a reference signal for a reconstruction of a first virtual pilot symbol. The virtual pilot manager 1230 is capable of, configured to, or operable to support a means for transmitting, in the slot and via the channel to the first wireless device, a first data symbol that is the first virtual pilot symbol with a first modulation scheme. The data manager 1235 is capable of, configured to, or operable to support a means for transmitting, in the slot to the first wireless device, a second data symbol with a second modulation scheme, where the first modulation scheme is different from the second modulation scheme.

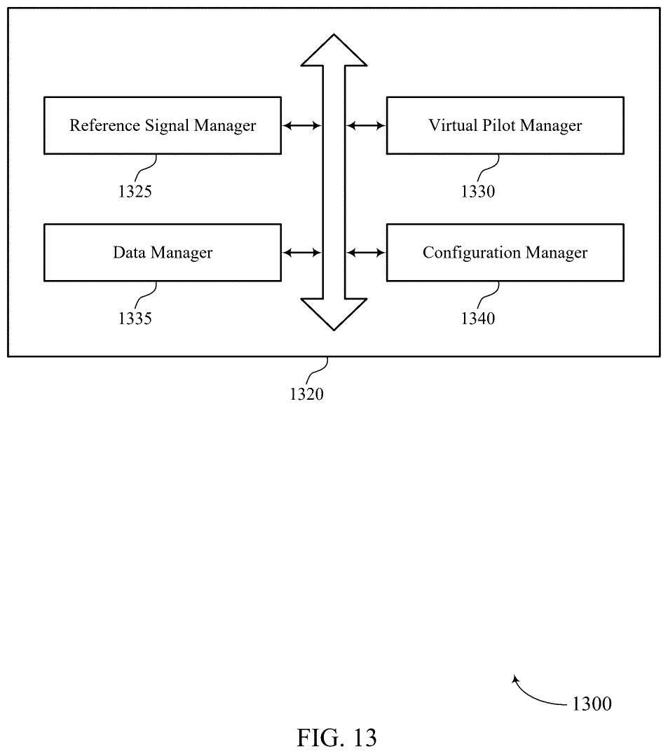

FIG. 13 shows a block diagram 1300 of a communications manager 1320 that supports data bearing virtual pilots in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of data bearing virtual pilots as described herein. For example, the communications manager 1320 may include a reference signal manager 1325, a virtual pilot manager 1330, a data manager 1335, a configuration manager 1340, or any combination thereof. Each of these components, or components or subcomponents thereof (e.g., one or more processors, one or more memories), may communicate, directly or indirectly, with one another (e.g., via one or more buses).

The reference signal manager 1325 is capable of, configured to, or operable to support a means for transmitting, in a slot and via a channel to a first wireless device, a first overhead symbol of a reference signal for a reconstruction of a first virtual pilot symbol. The virtual pilot manager 1330 is capable of, configured to, or operable to support a means for transmitting, in the slot and via the channel to the first wireless device, a first data symbol that is the first virtual pilot symbol with a first modulation scheme. The data manager 1335 is capable of, configured to, or operable to support a means for transmitting, in the slot to the first wireless device, a second data symbol with a second modulation scheme, where the first modulation scheme is different from the second modulation scheme.

In some examples, the virtual pilot manager 1330 is capable of, configured to, or operable to support a means for transmitting, via the channel to the first wireless device, a third data symbol that is a second virtual pilot symbol with a third modulation scheme, where the third modulation scheme is equal to, or different from, the first modulation scheme.

In some examples, a transport block size is associated with the first modulation scheme and the second modulation scheme.

In some examples, the first modulation scheme is a first modulation and coding scheme (MCS), and the second modulation scheme is a second MCS different from the first MCS. In some examples, the first data symbol is encoded with the first MCS and the second data symbol is encoded with the second MCS.

In some examples, the virtual pilot manager 1330 is capable of, configured to, or operable to support a means for transmitting, via the channel to the first wireless device, a third data symbol that is a second virtual pilot symbol with a third MCS, where the third MCS is equal to, or different from, the first MCS.

In some examples, the configuration manager 1340 is capable of, configured to, or operable to support a means for communicating, with the first wireless device, an indication of a configuration of the first modulation scheme for the first data symbol that is the first virtual pilot symbol.

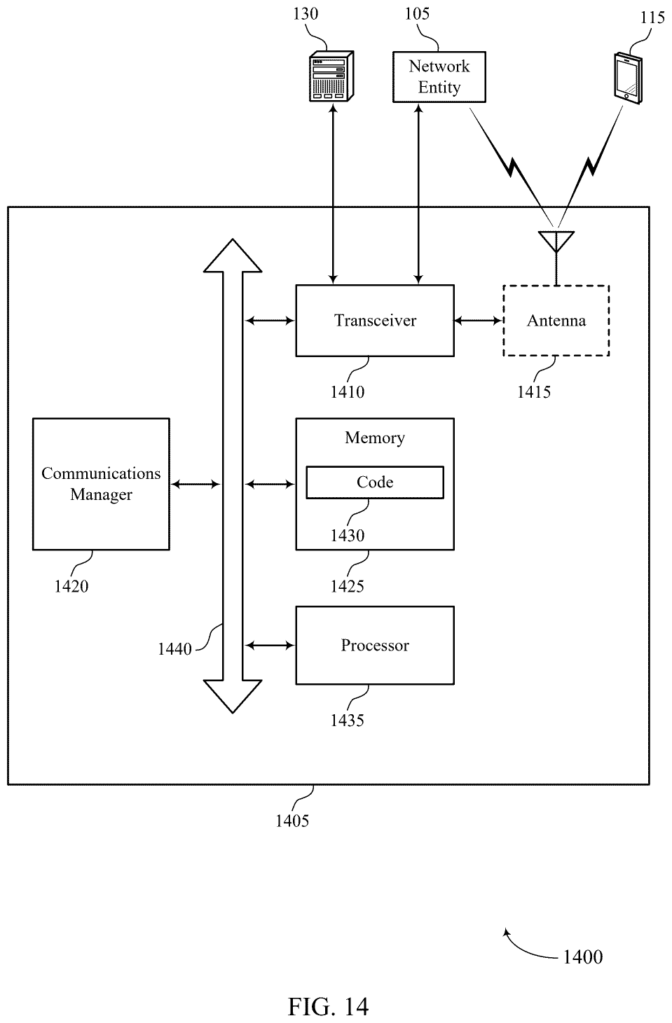

FIG. 14 shows a diagram of a system 1400 including a device 1405 that supports data bearing virtual pilots in accordance with one or more aspects of the present disclosure. The device 1405 may be an example of or include components of a device 1105, a device 1205, or a second wireless device as described herein. The device 1405 may include components for bi-directional voice and data communications including components for transmitting and receiving communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting data bearing virtual pilots). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

For example, the communications manager 1420 is capable of, configured to, or operable to support a means for transmitting, in a slot and via a channel to a first wireless device, a first overhead symbol of a reference signal for a reconstruction of a first virtual pilot symbol. The communications manager 1420 is capable of, configured to, or operable to support a means for transmitting, in the slot and via the channel to the first wireless device, a first data symbol that is the first virtual pilot symbol with a first modulation scheme. The communications manager 1420 is capable of, configured to, or operable to support a means for transmitting, in the slot to the first wireless device, a second data symbol with a second modulation scheme, where the first modulation scheme is different from the second modulation scheme.

By including or configuring the communications manager 1420 in accordance with examples as described herein, the device 1405 may support techniques for improved communication reliability, reduced latency, reduced power consumption, more efficient utilization of communication resources, improved coordination between devices, longer battery life, or improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of data bearing virtual pilots as described herein, or the at least one processor 1435 and the at least one memory 1425 may be otherwise configured to, individually or collectively, perform or support such operations.

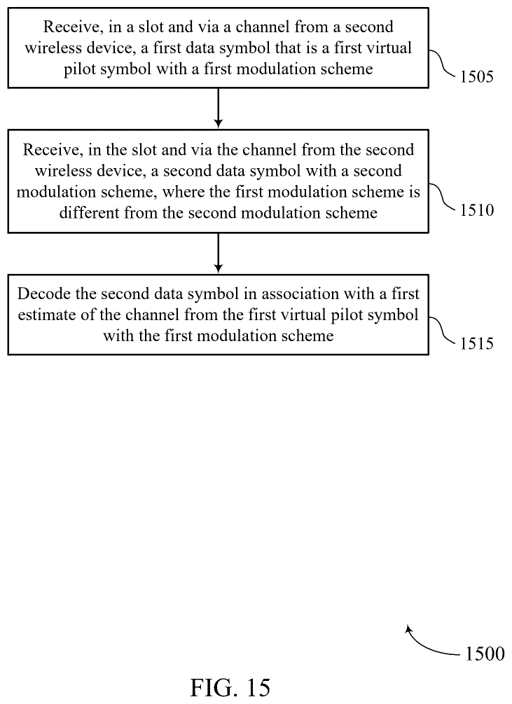

FIG. 15 shows a flowchart illustrating a method 1500 that supports data bearing virtual pilots in accordance with one or more aspects of the present disclosure. The operations of the method 1500 may be implemented by a first wireless device or its components as described herein. For example, the operations of the method 1500 may be performed by a first wireless device as described with reference to FIGS. 1 through 10. In some examples, a first wireless device may execute a set of instructions to control the functional elements of the first wireless device to perform the described functions. Additionally, or alternatively, the first wireless device may perform aspects of the described functions using special-purpose hardware.

At 1505, the method may include receiving, in a slot and via a channel from a second wireless device, a first data symbol that is a first virtual pilot symbol with a first modulation scheme. The operations of 1505 may be performed in accordance with examples as disclosed herein. In some examples, aspects of the operations of 1505 may be performed by a virtual pilot component 925 as described with reference to FIG. 9.

At 1510, the method may include receiving, in the slot and via the channel from the second wireless device, a second data symbol with a second modulation scheme, where the first modulation scheme is different from the second modulation scheme. The operations of 1510 may be performed in accordance with examples as disclosed herein. In some examples, aspects of the operations of 1510 may be performed by a data component 930 as described with reference to FIG. 9.

At 1515, the method may include decoding the second data symbol in association with a first estimate of the channel from the first virtual pilot symbol with the first modulation scheme. The operations of 1515 may be performed in accordance with examples as disclosed herein. In some examples, aspects of the operations of 1515 may be performed by a decode component 935 as described with reference to FIG. 9.

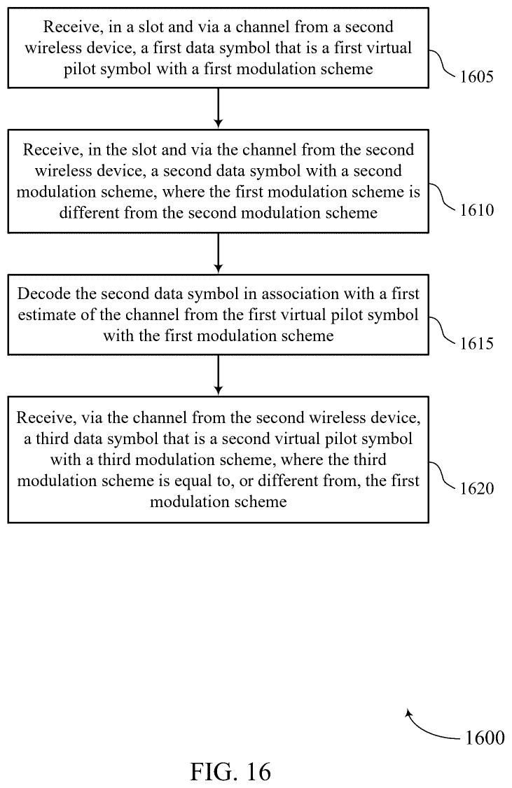

FIG. 16 shows a flowchart illustrating a method 1600 that supports data bearing virtual pilots in accordance with one or more aspects of the present disclosure. The operations of the method 1600 may be implemented by a first wireless device or its components as described herein. For example, the operations of the method 1600 may be performed by a first wireless device as described with reference to FIGS. 1 through 10. In some examples, a first wireless device may execute a set of instructions to control the functional elements of the first wireless device to perform the described functions. Additionally, or alternatively, the first wireless device may perform aspects of the described functions using special-purpose hardware.

At 1605, the method may include receiving, in a slot and via a channel from a second wireless device, a first data symbol that is a first virtual pilot symbol with a first modulation scheme. The operations of 1605 may be performed in accordance with examples as disclosed herein. In some examples, aspects of the operations of 1605 may be performed by a virtual pilot component 925 as described with reference to FIG. 9.

At 1610, the method may include receiving, in the slot and via the channel from the second wireless device, a second data symbol with a second modulation scheme, where the first modulation scheme is different from the second modulation scheme. The operations of 1610 may be performed in accordance with examples as disclosed herein. In some examples, aspects of the operations of 1610 may be performed by a data component 930 as described with reference to FIG. 9.

At 1615, the method may include decoding the second data symbol in association with a first estimate of the channel from the first virtual pilot symbol with the first modulation scheme. The operations of 1615 may be performed in accordance with examples as disclosed herein. In some examples, aspects of the operations of 1615 may be performed by a decode component 935 as described with reference to FIG. 9.

At 1620, the method may include receiving, via the channel from the second wireless device, a third data symbol that is a second virtual pilot symbol with a third modulation scheme, where the third modulation scheme is equal to, or different from, the first modulation scheme. The operations of 1620 may be performed in accordance with examples as disclosed herein. In some examples, aspects of the operations of 1620 may be performed by a virtual pilot component 925 as described with reference to FIG. 9.

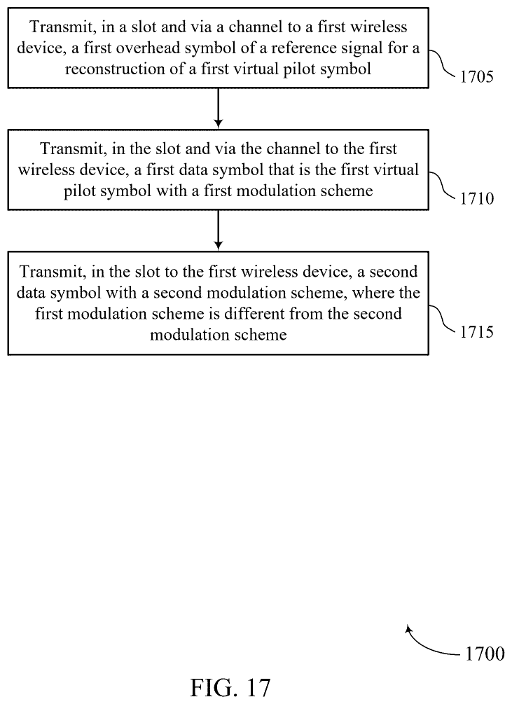

FIG. 17 shows a flowchart illustrating a method 1700 that supports data bearing virtual pilots in accordance with one or more aspects of the present disclosure. The operations of the method 1700 may be implemented by a second wireless device or its components as described herein. For example, the operations of the method 1700 may be performed by a second wireless device as described with reference to FIGS. 1 through 6 and 11 through 14. In some examples, a second wireless device may execute a set of instructions to control the functional elements of the second wireless device to perform the described functions. Additionally, or alternatively, the second wireless device may perform aspects of the described functions using special-purpose hardware.

At 1705, the method may include transmitting, in a slot and via a channel to a first wireless device, a first overhead symbol of a reference signal for a reconstruction of a first virtual pilot symbol. The operations of 1705 may be performed in accordance with examples as disclosed herein. In some examples, aspects of the operations of 1705 may be performed by a reference signal manager 1325 as described with reference to FIG. 13.

At 1710, the method may include transmitting, in the slot and via the channel to the first wireless device, a first data symbol that is the first virtual pilot symbol with a first modulation scheme. The operations of 1710 may be performed in accordance with examples as disclosed herein. In some examples, aspects of the operations of 1710 may be performed by a virtual pilot manager 1330 as described with reference to FIG. 13.

At 1715, the method may include transmitting, in the slot to the first wireless device, a second data symbol with a second modulation scheme, where the first modulation scheme is different from the second modulation scheme. The operations of 1715 may be performed in accordance with examples as disclosed herein. In some examples, aspects of the operations of 1715 may be performed by a data manager 1335 as described with reference to FIG. 13.

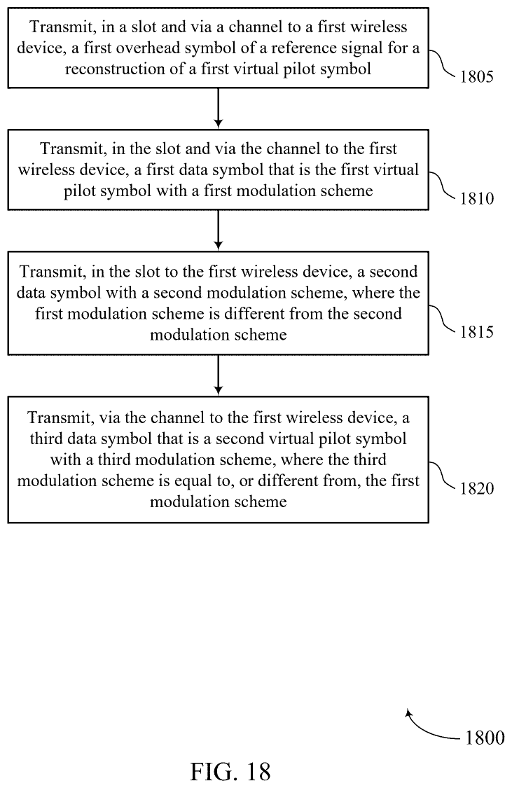

FIG. 18 shows a flowchart illustrating a method 1800 that supports data bearing virtual pilots in accordance with one or more aspects of the present disclosure. The operations of the method 1800 may be implemented by a second wireless device or its components as described herein. For example, the operations of the method 1800 may be performed by a second wireless device as described with reference to FIGS. 1 through 6 and 11 through 14. In some examples, a second wireless device may execute a set of instructions to control the functional elements of the second wireless device to perform the described functions. Additionally, or alternatively, the second wireless device may perform aspects of the described functions using special-purpose hardware.

At 1805, the method may include transmitting, in a slot and via a channel to a first wireless device, a first overhead symbol of a reference signal for a reconstruction of a first virtual pilot symbol. The operations of 1805 may be performed in accordance with examples as disclosed herein. In some examples, aspects of the operations of 1805 may be performed by a reference signal manager 1325 as described with reference to FIG. 13.

At 1810, the method may include transmitting, in the slot and via the channel to the first wireless device, a first data symbol that is the first virtual pilot symbol with a first modulation scheme. The operations of 1810 may be performed in accordance with examples as disclosed herein. In some examples, aspects of the operations of 1810 may be performed by a virtual pilot manager 1330 as described with reference to FIG. 13.

At 1815, the method may include transmitting, in the slot to the first wireless device, a second data symbol with a second modulation scheme, where the first modulation scheme is different from the second modulation scheme. The operations of 1815 may be performed in accordance with examples as disclosed herein. In some examples, aspects of the operations of 1815 may be performed by a data manager 1335 as described with reference to FIG. 13.

At 1820, the method may include transmitting, via the channel to the first wireless device, a third data symbol that is a second virtual pilot symbol with a third modulation scheme, where the third modulation scheme is equal to, or different from, the first modulation scheme. The operations of 1820 may be performed in accordance with examples as disclosed herein. In some examples, aspects of the operations of 1820 may be performed by a virtual pilot manager 1330 as described with reference to FIG. 13.

The following provides an overview of aspects of the present disclosure:
Aspect 1: A method for wireless communications at a first wireless device, comprising: receiving, in a slot and via a channel from a second wireless device, a first data symbol that is a first virtual pilot symbol with a first modulation scheme; receiving, in the slot and via the channel from the second wireless device, a second data symbol with a second modulation scheme, wherein the first modulation scheme is different from the second modulation scheme; and decoding the second data symbol in association with a first estimate of the channel from the first virtual pilot symbol with the first modulation scheme.
Aspect 2: The method of aspect 1, further comprising: receiving, via the channel from the second wireless device, a first overhead symbol of a reference signal in the slot with the first data symbol and the second data symbol, wherein a reconstruction of the first virtual pilot symbol is performed in association with a second estimate of the channel from the reference signal.
Aspect 3: The method of aspect 2, wherein the first estimate of the channel is determined in association with the reconstruction of the first virtual pilot symbol.
Aspect 4: The method of any of aspects 1 through 3, further comprising: receiving, via the channel from the second wireless device, a third data symbol that is a second virtual pilot symbol with a third modulation scheme, wherein the third modulation scheme is equal to, or different from, the first modulation scheme.
Aspect 5: The method of aspect 4, wherein the third data symbol is received after the first data symbol in the slot.
Aspect 6: The method of any of aspects 1 through 5, wherein a transport block size is associated with the first modulation scheme and the second modulation scheme.
Aspect 7: The method of any of aspects 1 through 6, wherein the first modulation scheme is a first modulation and coding scheme (MCS), the second modulation scheme is a second MCS different from the first MCS, the first data symbol is encoded with the first MCS, and the second data symbol is encoded with the second MCS.
Aspect 8: The method of aspect 7, further comprising: receiving, via the channel from the second wireless device, a third data symbol that is a second virtual pilot symbol with a third MCS, wherein the third MCS is equal to, or different from, the first MCS.
Aspect 9: The method of any of aspects 7 through 8, wherein the first data symbol is encoded in a first code block with a first code rate, and the second data symbol is encoded separately from the first code block in a second code block with a second code rate.
Aspect 10: The method of any of aspects 1 through 9, further comprising: communicating, with the second wireless device, an indication of a configuration of the first modulation scheme for the first data symbol that is the first virtual pilot symbol.
Aspect 11: The method of aspect 10, wherein the indication is received in a first control information field associated with the first virtual pilot symbol that is separate from a second control information field associated with the second data symbol.
Aspect 12: The method of any of aspects 10 through 11, wherein the indication is an offset relative to a second MCS associated with the second data symbol.
Aspect 13: The method of any of aspects 10 through 12, wherein the configuration comprises one or more locations in time or frequency of the first data symbol that is the first virtual pilot symbol.
Aspect 14: A method for wireless communications at a second wireless device, comprising: transmitting, in a slot and via a channel to a first wireless device, a first overhead symbol of a reference signal for a reconstruction of a first virtual pilot symbol; transmitting, in the slot and via the channel to the first wireless device, a first data symbol that is the first virtual pilot symbol with a first modulation scheme; and transmitting, in the slot to the first wireless device, a second data symbol with a second modulation scheme, wherein the first modulation scheme is different from the second modulation scheme.
Aspect 15: The method of aspect 14, further comprising: transmitting, via the channel to the first wireless device, a third data symbol that is a second virtual pilot symbol with a third modulation scheme, wherein the third modulation scheme is equal to, or different from, the first modulation scheme.
Aspect 16: The method of any of aspects 14 through 15, wherein a transport block size is associated with the first modulation scheme and the second modulation scheme.
Aspect 17: The method of any of aspects 14 through 16, wherein the first modulation scheme is a first modulation and coding scheme (MCS), the second modulation scheme is a second MCS different from the first MCS, the first data symbol is encoded with the first MCS, and the second data symbol is encoded with the second MCS.
Aspect 18: The method of aspect 17, further comprising: transmitting, via the channel to the first wireless device, a third data symbol that is a second virtual pilot symbol with a third MCS, wherein the third MCS is equal to, or different from, the first MCS.
Aspect 19: The method of any of aspects 14 through 18, further comprising: communicating, with the first wireless device, an indication of a configuration of the first modulation scheme for the first data symbol that is the first virtual pilot symbol.
Aspect 20: A first wireless device comprising one or more memories storing processor-executable code, and one or more processors coupled with the one or more memories and individually or collectively operable to execute the code to cause the first wireless device to perform a method of any of aspects 1 through 13.
Aspect 21: A first wireless device comprising at least one means for performing a method of any of aspects 1 through 13.
Aspect 22: A non-transitory computer-readable medium storing code the code comprising instructions executable by one or more processors to perform a method of any of aspects 1 through 13.
Aspect 23: A second wireless device comprising one or more memories storing processor-executable code, and one or more processors coupled with the one or more memories and individually or collectively operable to execute the code to cause the second wireless device to perform a method of any of aspects 14 through 19.
Aspect 24: A second wireless device comprising at least one means for performing a method of any of aspects 14 through 19.
Aspect 25: A non-transitory computer-readable medium storing code the code comprising instructions executable by one or more processors to perform a method of any of aspects 14 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
receive, in a slot and via a channel from a second wireless device, a first data symbol that is a first virtual pilot symbol with a first modulation scheme;
receive, in the slot and via the channel from the second wireless device, a second data symbol with a second modulation scheme,
wherein the first modulation scheme is different from the second modulation scheme; and
decode the second data symbol in association with a first estimate of the channel from the first virtual pilot symbol with the first modulation scheme.

2. The first wireless device of claim 1, wherein the one or more processors are individually or collectively further operable to execute the code to cause the first wireless device to:
receive, via the channel from the second wireless device, a first overhead symbol of a reference signal in the slot with the first data symbol and the second data symbol,
wherein a reconstruction of the first virtual pilot symbol is performed in association with a second estimate of the channel from the reference signal.

3. The first wireless device of claim 2, wherein the first estimate of the channel is determined in association with the reconstruction of the first virtual pilot symbol.

4. The first wireless device of claim 1, wherein the one or more processors are individually or collectively further operable to execute the code to cause the first wireless device to:
receive, via the channel from the second wireless device, a third data symbol that is a second virtual pilot symbol with a third modulation scheme,
wherein the third modulation scheme is equal to, or different from, the first modulation scheme.

5. The first wireless device of claim 4, wherein the third data symbol is received after the first data symbol in the slot.

6. The first wireless device of claim 1, wherein a transport block size is associated with the first modulation scheme and the second modulation scheme.

7. The first wireless device of claim 1, wherein:
the first modulation scheme is a first modulation and coding scheme (MCS), and the second modulation scheme is a second MCS different from the first MCS, and
the first data symbol is encoded with the first MCS and the second data symbol is encoded with the second MCS.

8. The first wireless device of claim 7, wherein the one or more processors are individually or collectively further operable to execute the code to cause the first wireless device to:
receive, via the channel from the second wireless device, a third data symbol that is a second virtual pilot symbol with a third MCS,
wherein the third MCS is equal to, or different from, the first MCS.

9. The first wireless device of claim 7, wherein the first data symbol is encoded in a first code block with a first code rate, and the second data symbol is encoded separately from the first code block in a second code block with a second code rate.

10. The first wireless device of claim 1, wherein the one or more processors are individually or collectively further operable to execute the code to cause the first wireless device to:
communicate, with the second wireless device, an indication of a configuration of the first modulation scheme for the first data symbol that is the first virtual pilot symbol.

11. The first wireless device of claim 10, wherein the indication is received in a first control information field associated with the first virtual pilot symbol that is separate from a second control information field associated with the second data symbol.

12. The first wireless device of claim 10, wherein the indication is an offset relative to a second MCS associated with the second data symbol.

13. The first wireless device of claim 10, wherein the configuration comprises one or more locations in time or frequency of the first data symbol that is the first virtual pilot symbol.

14. A second wireless device, comprising:
one or more memories storing processor-executable code; and
one or more processors coupled with the one or more memories and individually or collectively operable to execute the code to cause the second wireless device to:
transmit, in a slot and via a channel to a first wireless device, a first overhead symbol of a reference signal for a reconstruction of a first virtual pilot symbol;
transmit, in the slot and via the channel to the first wireless device, a first data symbol that is the first virtual pilot symbol with a first modulation scheme; and
transmit, in the slot to the first wireless device, a second data symbol with a second modulation scheme,
wherein the first modulation scheme is different from the second modulation scheme.

15. The second wireless device of claim 14, wherein the one or more processors are individually or collectively further operable to execute the code to cause the second wireless device to:
transmit, via the channel to the first wireless device, a third data symbol that is a second virtual pilot symbol with a third modulation scheme,
wherein the third modulation scheme is equal to, or different from, the first modulation scheme.

16. The second wireless device of claim 14, wherein a transport block size is associated with the first modulation scheme and the second modulation scheme.

17. The second wireless device of claim 14, wherein:
the first modulation scheme is a first modulation and coding scheme (MCS), and the second modulation scheme is a second MCS different from the first MCS, and
the first data symbol is encoded with the first MCS and the second data symbol is encoded with the second MCS.

18. The second wireless device of claim 17, wherein the one or more processors are individually or collectively further operable to execute the code to cause the second wireless device to:
transmit, via the channel to the first wireless device, a third data symbol that is a second virtual pilot symbol with a third MCS,
wherein the third MCS is equal to, or different from, the first MCS.

19. The second wireless device of claim 14, wherein the one or more processors are individually or collectively further operable to execute the code to cause the second wireless device to:
communicate, with the first wireless device, an indication of a configuration of the first modulation scheme for the first data symbol that is the first virtual pilot symbol.

20. A method for wireless communications at a first wireless device, comprising:
receiving, in a slot and via a channel from a second wireless device, a first data symbol that is a first virtual pilot symbol with a first modulation scheme;
receiving, in the slot and via the channel from the second wireless device, a second data symbol with a second modulation scheme,
wherein the first modulation scheme is different from the second modulation scheme; and
decoding the second data symbol in association with a first estimate of the channel from the first virtual pilot symbol with the first modulation scheme.
